(19) United States
(12) Patent Application Publication
(10) Pub. No.: US 2025/0354411 A1
(43) Pub. Date: Nov. 20, 2025

(54) DEVICES, SYSTEMS, AND METHODS FOR HASP RETENTION SELF-STORAGE LOCK ASSEMBLY

(71) Applicant: JANUS INTERNATIONAL GROUP, LLC, Temple, GA (US)

(72) Inventors: David P. GENGLER, Draper, UT (US); John Morgan HODGES, Sarasota, FL (US); Alan CAMPBELL, Douglasville, GA (US); Tony Tungsing LI, Atlanta, GA (US)

(21) Appl. No.: 19/288,904

(22) Filed: Aug. 1, 2025

Related U.S. Application Data
(63) Continuation-in-part of application No. 19/094,340, filed on Mar. 28, 2025.
(60) Provisional application No. 63/571,568, filed on Mar. 29, 2024.

(51) Int. Cl. E05B 47/00

(52) U.S. Cl. CPC E05B 47/0012; E05B 47/0046; E05B 2047/0017; E05B 2047/002

(57) ABSTRACT

An electronic self-storage locking system includes a self-storage door assembly including a self-storage door and door frame, and an electronic self-storage lock assembly comprising a hasp assembly with movable hasp, a hasp retention assembly for selectively retaining the hasp, and a retention control system for governing operation of the hasp retention system.

### CROSS-REFERENCE TO RELATED APPLICATIONS

This application is a CIP application of U.S. application Ser. No. 19/094,340, filed Mar. 28, 2025, which claims the benefit of and priority to U.S. Provisional Application No. 63/571,568 filed Mar. 29, 2024, the disclosures of which are incorporated by reference herein in their entirety.

### FIELD

The present disclosure generally relates to devices, systems, and methods for access security for a door within a self-storage facility, and more specifically for hasp retention security.

### BACKGROUND

Self-storage facilities often rent or lease storage space to tenants such as individuals and businesses. A self-storage facility may separate its storage space by unit. While a unit can be anything from lockers, containers, to even outdoor spaces, a typical unit often corresponds to an enclosed and climate-controlled room that is accessible via a lockable door. A self-storage facility may use electronic-style locking systems of various kinds.

However, installing and/or upgrading facilities to electronic systems can be burdensome. For example, existing infrastructure may not be conducive to spatial and access requirements and/or may require expensive configurations to avoid extensive labor and/or alterations.

### SUMMARY

According to an aspect of the present disclosure, an electronic lock assembly may include a hasp assembly configured for coupling with a self-storage door, the hasp assembly including a hasp movable between extended and retracted positions. The hasp may include a retention notch. The electronic lock assembly may include a hasp retention assembly for selectively retaining the hasp. The hasp retention assembly may be configured for coupling with a door frame and may define a hasp passageway formed to receive the hasp therein in the extended position. The hasp retention assembly may include a latch plate arranged for movement between an unlatched position to permit movement of the hasp out of the extended position towards the retracted position and a latched position blocking against movement of the hasp out from the extended position within the hasp passageway towards the retracted position. The latch plate may include a hasp opening arranged to define at least a portion of the hasp passageway. In the extended position within the hasp passageway, the hasp may be arranged with alignment between the retention notch and the hasp opening such that arrangement of the latch plate in the latched position can engage the latch plate with the retention notch to block against movement of the hasp out from the extended position towards the retracted position. The hasp retention system may include an operation assembly configured to operate the latch plate between the unlatched and latched positions. The operation assembly may include a pivot key and a drive gear resiliently coupled with the pivot key to provide rotational force to the pivot key. The pivot key may be arranged for engagement with the latch plate to provide driving movement of the latch plate between the latched and unlatch positions under rotational pivoting of the pivot key. The hasp retention system may include a retention control system configured for governing operation of the latch plate between the latched and unlatched positions. The retention control system may include a sensor system including at least one pivot key sensor configured to sense positioning of the pivot key and at least one sensor configured to sense positioning of the drive gear.

In some embodiments, the at least one pivot key sensor may be arranged to sense the pivot key being seated in a closed position. The closed position may correspond with the latched position of the latch plate to establish secure locking of the hasp within the hasp passageway. The sensor system may be configured to determine as faulty locking when the pivot key is unseated from, but close to, the closed position.

In some embodiments, the sensor system may be configured to determine as faulty locking upon both of: (i) the pivot key is unseated from, but close to, the closed position, and (ii) the drive gear achieves a closed position corresponding with the latched position of the latch plate. The pivot key may include a pivot key magnet arranged to pass in proximity to the pivot key sensor under movement of the pivot key. The pivot key sensor may arranged on a control board of the retention control system. In some embodiments, the pivot key sensor may be positioned to one side of the latch plate and the pivot key is positioned to another side of the latch plate opposite the one side.

In some embodiments, the pivot key may include a body for pivoting rotation about an axis thereof. The pivot key may include an arm extending from the body for engagement with the latch plate. The pivot key magnet may be positioned to define a magnet path relative to the pivot key sensor under pivoting movement of the pivot key. In some embodiments, the pivot key magnet may be arranged such that, in the seated position of the pivot key, the pivot key magnet is positioned along the magnet path closest to the pivot key sensor.

In some embodiments, the pivot key magnet may be arranged such that, in the seated position of the pivot key, the pivot key magnet is oriented with a pole end thereof directed towards the pivot key sensor to emphasize magnetic field towards the pivot key sensor. The pivot key magnet may be arranged such that, out from the seated position of the pivot key, the pivot key magnet is oriented with the pole end thereof misdirected from the pivot key sensor to deemphasize magnetic field towards the pivot key sensor.

In some embodiments, the latch plate may define a slot. The pivot key may extend within the slot for selective engagement with an end face defining at least a portion of the slot to maintain the latch plate in the latch position. The pivot key magnet may be arranged such that, in the seated position of the pivot key, the pivot key magnet is oriented with a pole end thereof directed towards the pivot key sensor through the slot of the latch plate to emphasize magnetic field towards the pivot key sensor.

In some embodiments, the drive gear sensor may be configured to sense the drive gear positioned in a closed position encouraging the pivot key towards a closed position which corresponds with the latched position of the latch plate. The drive gear may include a gear-closed magnet arranged to pass in proximity to the drive gear sensor under movement of the drive gear to indicate the closed position of the drive gear. The drive gear sensor may be arranged on a control board of the retention control system.

In some embodiments, the drive gear sensor, may be positioned to one side of the latch plate and the drive gear is positioned to another side of the latch plate opposite the one side. The drive gear sensor may be configured to sense the drive gear positioned in an open position encouraging the pivot key into an open position which corresponds with the unlatched position of the latch plate. The drive gear may include a gear-open magnet arranged to pass in proximity to the drive gear sensor under movement of the drive gear to indicate the open position of the drive gear. In some embodiments, the drive gear sensor may be arranged on a control board of the retention control system. The drive gear sensor may be positioned to one side of the latch plate and the drive gear may be positioned to another side of the latch plate opposite the one side.

In some embodiments, the retention control system may be configured to control the operation assembly for overdrive in response to a determination of jamming. Overdrive may include increasing torque to the pivot key. Overdrive may include operating the drive gear for rotation beyond a closed position to increase encouragement of the pivot key towards a closed position which corresponds with the latched position of the latch plate.

In some embodiments, jamming may include inability to seat the pivot key in a closed position. The closed position may correspond with the latched position of the latch plate to establish secure locking of the hasp within the hasp passageway. Determination of jamming may include determination of incongruence between position of the drive gear in a closed position and lack of position of the pivot key in a closed position.

In some embodiments, the retention control system may be configured to communicate to provide a jamming message in response to a determination of jamming. In response to a determination of jamming of the latch plate for unlocking, the retention control system may communicate a signal to provide the jamming message to a user via a personal mobile device. The jamming message may include instructions to manually move the hasp to assist unbinding.

In some embodiments, the retention control system may be configured to communicate to provide the jamming message by local wireless communication with the user's personal mobile device. The retention control system may be configured to communicate to provide a jamming message by communication with a server for communication with the user's personal mobile device. In some embodiments, the sensor system may include a latch plate sensor configured to sense positioning of the latch plate.

According to another aspect of the present disclosure, an electronic self-storage locking system may include a self-storage door assembly comprising a storage door and a door frame and an electronic lock assembly as disclosed herein.

According to still another aspect of the present disclosure, an electronic hasp retention system for selectively retaining a hasp of a lock for a self-storage door assembly may include a hasp retention assembly and a retention control system. The hasp retention assembly may be configured for coupling with a door frame and may define a hasp passageway formed to receive the hasp of the lock therein in an extended position. The hasp retention assembly may include a latch plate arranged for movement between an unlatched position to permit movement of the hasp of the lock out of the extended position towards the retracted position and a latched position blocking against movement of the hasp of the lock out from the extended position within the hasp passageway towards the retracted position. The latch plate may include a hasp opening arranged to define at least a portion of the hasp passageway. The hasp passageway may be defined to receive the hasp with alignment between a retention notch and the hasp opening such that arrangement of the latch plate in the latched position can engage the latch plate with the retention notch to block against movement of the hasp out from the extended position towards the retracted position. The hasp retention assembly may include an operation assembly configured to drive the latch plate between the unlatched and latched positions. The operation assembly may include a pivot key and a drive gear resiliently coupled with the pivot key to provide rotational force to the pivot key. The pivot key may be arranged for engagement with the latch plate to provide driving movement of the latch plate between the latched and unlatch positions under rotational pivoting of the pivot key. The hasp retention assembly may include a retention control system configured for governing operation of the latch plate between the latched and unlatched positions. The retention control system may include a sensor system including at least one pivot key sensor configured to sense positioning of the pivot key and at least one sensor configured to sense positioning of the drive gear.

According to still another aspect of the present disclosure, an electronic lock assembly may include a hasp assembly configured for coupling with a self-storage door, the hasp assembly including a hasp movable between extended and retracted positions, a hasp retention assembly for selectively retaining the hasp, the hasp retention assembly comprising a frame configured for coupling with a door frame and defining a hasp passageway formed to receive the hasp therein in the extended position, and a latch plate arranged for movement between an unlatched position permitting movement of the hasp out of the extended position towards the retracted position and a latched position blocking against movement of the hasp out from the extended position within the hasp passageway towards the retracted position. Retaining may include blocking against retraction of the hasp. The hasp may include a retention notch. The latch plate may include a hasp opening arranged to define at least a portion of the hasp passageway, wherein in the extended position within the hasp passageway, the hasp may be arranged with alignment between the retention notch and the hasp opening such that arrangement of the latch plate in the latched position can engage the latch plate with the retention notch to block against movement of the hasp out from the extended position towards the retracted position. The assembly may include a retention control system configured for governing operation of the latch plate between the latched and unlatched positions.

In some embodiments, the retention control system may include at least one sensor arranged to detect the presence of the hasp within the hasp passageway in the extended position. The retention control system may be configured to automatically operate to move the latch plate to the latched position responsive to detection that the hasp is entered within the hasp passageway in the extended position. The retention control system may be configured to operate to move the latch plate from the latched position into the unlatched position responsive to an unlocking command.

In some embodiments, the unlocking command may be received from a local user. The unlocking command may be a wireless request signal generated by a mobile device of the local user arranged near to the electronic lock assembly. The local user may be a tenant of a self-storage unit to which the electronic storage locking system is deployed.

In some embodiments, the hasp retention system may include a pivot key arranged for rotational movement between an unrestricted position to drive the latch plate to the unlatched position to allow the hasp to be removed from the hasp passageway and a restricted position to drive the latch plate to the latched position to retain the hasp to prevent removal from the hasp passageway. The pivot key may include a body for pivoting rotation about an axis thereof. The pivot key may include an arm extending from the body for engagement with the latch plate.

In some embodiments, the latch plate may define a slot. The slot may extend longitudinally. The pivot key may extend within the slot for selective engagement with an end face defining at least a portion of the slot to maintain the latch plate in the latch position. The pivot key may include an abutment surface for engagement with the latch plate. The abutment surface may extending tangentially relative to direction of pivoting rotation about the rotation axis of the pivot key at the restricted position. In the restricted position of the pivot key, the abutment surface may be configured to engage with the end face of slot of the latch plate to block against movement of the latch plate out from the latched position.

In some embodiments, in the restricted position, the pivot key may be arranged with the abutment surface aligned to abut with the end face of the slot of the latch plate under movement of the latch plate out from the latched position to block against movement of the latch plate out from the latched position as locking. The pivot key may be arranged to pass the abutment surface out of alignment with the end face of the slot under rotational movement of the pivot key towards the unrestricted position to allow transition of the latch plate to the unlatched position as unlocking. In some embodiments, the pivot key and latch plate may be arranged such that abutment between the abutment surface and the end face of the slot, as locking, occurs with movement of the latch plate towards the unlatch position driving force radially into the pivot key.

In some embodiments, in the restricted position, the pivot key may extend at least partially into the slot of the latch plate. The latch plate may be arranged to move linearly between the latched and unlatched positions. The latch plate may be arranged to move linearly and tangentially or secantially with partial overlap relative to the pivoting rotation of the pivot key from the restricted position. The latch plate may be arranged to move linearly and tangentially relative to or secantially with partial overlap of the pivoting rotation of the pivot key as defined by a path of traverse of the abutment surface.

In some embodiments, the retention control system may comprise an actuator and a gear. The gear may be coupled with the pivot key to communicate pivoting rotation to the pivot key. The actuator may be configured to rotate the gear responsive to commands for locking and unlocking.

In some embodiments, the gear may be coupled with the pivot key via a resilient connection to transmit resilient force of rotation from the gear to the pivot key. The resilient connection may include a rotational spring arranged to engage the pivot key on one end and to engage with the gear on another end such that gear rotation provides torque force to the rotational spring and applies resilient torque force to the pivot key.

In some embodiments, the gear may include a hub and a shaft. The hub and the shaft may each extend coaxially. The hub and shaft may define a spring receiver radially therebetween. The rotational spring may be received at least partially within the spring receiver having the other end engaged with a circumferentially facing surface to apply torque force to the rotational spring. In some embodiments, the rotational spring may be formed as a coil. The rotational spring may be mounted on the shaft. The one end of the torsional spring may be radially offset from the coil and may engage with the pivot key to apply torque force.

In some embodiments, the hasp assembly may include no electronic locking device. The hasp assembly may include an external manual locking device.

According to another aspect of the present disclosure, an electronic self-storage locking system may include a self-storage door assembly comprising a storage door and a door frame; a hasp assembly coupled with the self-storage door, the hasp assembly including a hasp movable between extended and retracted positions; and a hasp retention assembly for selectively retaining the hasp. Retaining the hasp may include blocking against retraction of the haps. The hasp may include a retention notch. The hasp retention may include a frame coupled with the door frame and defining a hasp passageway formed to receive the hasp therein in the extended position, and a latch plate arranged for movement between an unlatched position permitting movement of the hasp out of the extended position towards the retracted position and a latched position blocking against movement of the hasp out from the extended position within the hasp passageway towards the retracted position. The latch plate may include a hasp opening arranged to define at least a portion of the hasp passageway. In the extended position within the hasp passageway, the hasp may be arranged with alignment between the retention notch and the hasp opening such that arrangement of the latch plate in the latched position can engage the latch plate with the retention notch to block against movement of the hasp out from the extended position towards the retracted position. The system may include a retention control system configured for governing operation of the latch plate between the latched and unlatched positions.

According to another aspect of the present disclosure, an electronic lock for a self-storage door assembly may include a hasp retention assembly for selectively retaining a hasp of a self-storage door. Retaining may include blocking against retraction of the hasp. The hasp retention assembly may include a frame coupled with a door frame and defining a hasp passageway formed to receive a hasp therein in an extended position from a self-storage door, and a latch plate arranged for movement between an unlatched position permitting movement of the hasp out of the extended position towards the retracted position and a latched position blocking against movement of the hasp out from the extended position within the hasp passageway towards the retracted position. The latch plate may include a hasp opening arranged to define at least a portion of the hasp passageway. In the extended position within the hasp passageway, the hasp may be arranged with alignment between the retention notch and the hasp opening such that arrangement of the latch plate in the latched position engages the latch plate with the retention notch to block against movement of the hasp out from the extended position towards the retracted position. The electronic lock may include a retention control system configured for governing operation of the latch plate between the latched and unlatched positions.

In some embodiments, the electronic lock may be coupled with a bus assembly for communication with one or more operations modules. The one or more operations modules may include an access module, an input module, an output module, a motion detection module, an occupancy module, an environmental module, an indicator module, a wireless communications module, a 3rd party access modules, and/or other modules.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is an elevation view of an electronic self-storage locking system including a self-storage door and door frame, and an electronic lock assembly for selectively locking and unlocking the storage door for access to storage, showing that a hasp assembly secured with the storage door having a hasp arranged in a latched position in engagement with a (electronic) hasp retention assembly secured with the door frame for selectively retaining the latch in the latched positon to block against unlocking;

FIG. 2 is a partially isolated perspective view of the electronic lock assembly of the electronic self-storage locking system of FIG. 1 indicating that the hasp extends through the door frame for engagement with the hasp retention assembly;

FIG. 3 is a partially exploded perspective view of the hasp retention system of the electronic self-storage locking system of FIGS. 1 and 2, showing that the hasp retention system includes a frame defining a hasp passageway for receiving the hasp, and a latch plate arranged in an unlatched position and having a hasp opening defining at least a portion of the hasp passageway, and a pivot key for movement of the latch plate;

FIG. 4 is a partially exploded perspective view of the hasp retention system of the electronic self-storage locking system similar to FIG. 3, showing that the pivot key has rotated to drive the latch plate into a latched position to misalign the hasp opening within the remainder of the hasp passageway to block against movement of the hasp out from the extended position;

FIGS. 5 & 6 are elevation views of the hasp retention system of FIGS. 3 and 4, respectively, showing the interaction between the pivot key and latch plate in the respective unlatched and latched positions of the latch plate and corresponding unrestricted and restricted positions of the pivot key, and indicating that in the restricted position the pivot key is arranged to engage with an end face of a slot of the latch plate to block against movement of the latch plate towards the unlatched position;

FIG. 7 is an exploded perspective view of the hasp retention assembly showing that a retention control system includes an actuator and gear for driving rotational movement of the pivot key, and showing that the gear and the pivot key are coupled with a resilient connection via a torsional spring for resiliently transmitting torque force, and showing that a sensor system is arranged to detect the presence of the hasp within the hasp passageway;

FIG. 8 is an exploded perspective view of portions of the hasp retention assembly and retention control system, indicating certain aspects with additional detail, for example, the gear having a hub and shaft for receiving the rotational spring for coupling with the pivot key;

FIG. 9 is a plan view of portions of the electronic lock assembly in isolation to illustrate the hasp in the extended position, and the latch plate in the latched position to block against movement of the latch out from the extended position as locking;

FIG. 10 is a diagrammatic view of the electronic lock assembly in communication with a personal mobile device and in communication with a network and server;

FIG. 11 is a diagrammatic view of the electronic self-storage locking system of FIG. 1 showing the electronic lock assembly including a Noke bus assembly embodied as a field bus assembly adapted for communication with a number of operational modules each of which can be implemented as a portion of the a retention control system;

FIG. 12 is a combination of diagrammatic view of a sensor system with an elevation view of the electronic self-storage locking system of FIG. 1;

FIGS. 13 & 14 are each partial cross-sectional elevation views of the electronic lock assembly having the pivot key in an unclosed position in FIG. 13 in which mis-operation has blocked against the pivot key achieving a fully closed position, and in the closed position corresponding with locking in FIG. 14, and showing a pivot key sensor of the sensor system is arranged to sense positioning of the pivot key;

FIGS. 15 & 16 are each partial cross-sectional elevation views of the electronic lock assembly having the gear in an open position in FIG. 15, and in a closed position corresponding with locking in FIG. 16, and showing a gear sensor of the sensor system is arranged to sense positioning of the gear;

FIGS. 17 & 18 are each partial cross-sectional elevation views of the electronic lock assembly having the latch plate in an open position in FIG. 17 corresponding with the unlatched position, and out from the open position towards the latched position in FIG. 18, and showing a latch plate sensor of the sensor system is arranged to sense positioning of the latch plate;

FIG. 19 is a partial cross-sectional elevation view of the electronic lock assembly illustrating a mis-operation in which a head of the hasp remains partly within the hasp opening of the latch plate blocking against the latch plate achieving locking;

FIG. 19 is a partial cross-sectional elevation view of the electronic lock assembly illustrating a mis-operation in which hasp remains partly engaged laterally within the latch plate for example by friction, blocking against the latch plate achieving locking as locking restricted;

FIG. 21 is a diagrammatic view of an operation for managing mis-operation such as jamming;

FIG. 22 is a partial cross-sectional elevation view of the electronic lock assembly illustrating a mis-operation in which hasp remains partly engaged laterally within the latch plate for example by friction, blocking against the latch plate achieving unlocking as unlocking restricted;

FIG. 23 is a diagrammatic view of an operation for managing mis-operation such as jamming;

FIG. 24 is a perspective view of another embodiment of a gear having another implementation of a gear sensor as a part of the sensor system;

FIG. 25 is a partial cross-sectional elevation view of the electronic lock assembly illustrating the gear of FIG. 24; and

FIG. 26 is a partial cross-sectional elevation view of the electronic lock assembly including an inductive sensor arranged to sense the presence of the hasp within the hasp passageway.

### DETAILED DESCRIPTION

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It ill be readily understood that the aspects of the present disclosure, as generally described herein and illustrated in the figures can be arranged, substituted, combined, separated, and designed in a wide variety of different configurations, all of which are contemplated herein.

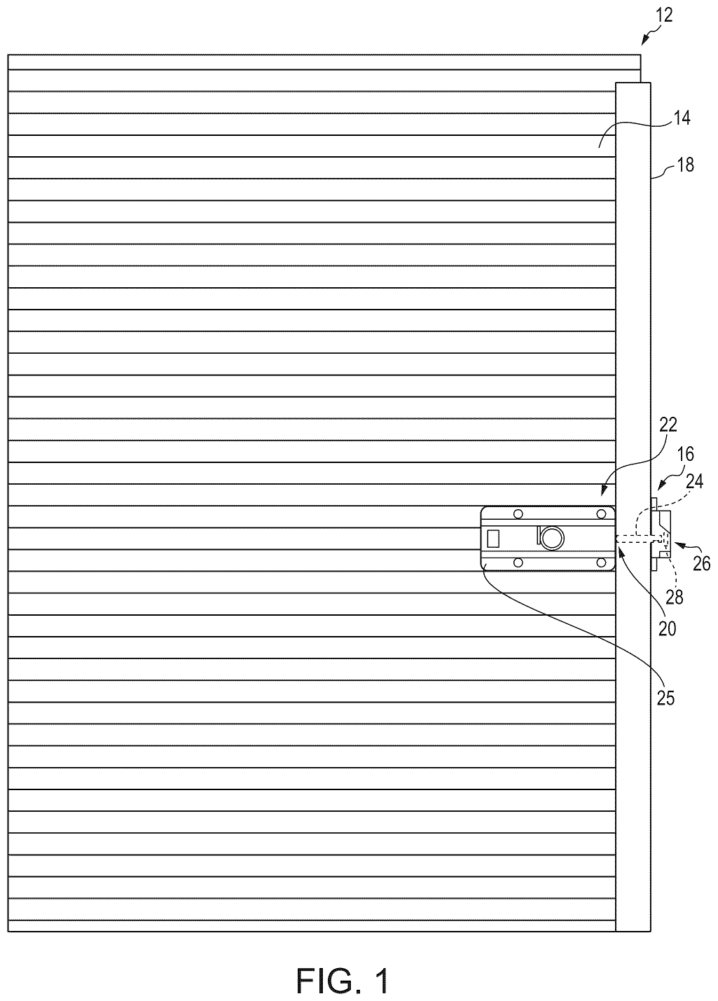

Referring to FIG. 1, a self-storage unit of a self-storage facility is shown including an electronic self-storage locking system 12 including a self-storage door 14 and an electronic lock assembly 16 for selectively blocking movement of the self-storage door 14 to block access to the storage unit. The electronic self-storage locking system 12 includes a door frame 18 which defines a self-storage door assembly together with the self-storage door 14. The self-storage door 14 is illustratively embodied as a corrugated roll-up style door, shown in a closed position, which is supported by the door frame 18 installed as structure of the facility, for movement of the self-storage door 14. For example, the self-storage door 14 can illustratively roll its corrugated sections up into an open position to allow access to storage, typically by rolling onto an above-mounted roll or sliding onto an extended section, and sliding along the door frame 18 as a track. As discussed in additional detail herein, the electronic lock assembly 16 can selectively engage through an opening or slot 20 in the door frame 18 to block against movement of the self-storage door 14.

The electronic lock assembly 16 illustratively includes a hasp assembly 22 with a movable hasp 24 within a housing 25 for coupling the self-storage door, and a hasp retention assembly 26 for coupling with the door frame 18 for selectively retaining the hasp 24. The electronic lock assembly 16 illustratively includes a retention control system 28 for governing operation of the hasp retention assembly 26 to selectively retain the hasp 24. For normal operation and access to storage, for example, by a tenant of the self-storage unit, the tenant can operate the hasp retention assembly 26 via the retention control system 28 to unlock the unit for access to storage.

As discussed in additional detail herein, the hasp retention assembly 26 and retention control system 28 can include electronic operation. In the illustrative embodiment, the hasp retention assembly 26 and retention control system 28 are coupled with the door frame 18 such that electrical power can be provided to stationary features which are not affixed to the movable self-storage door 14. Thus, the physical connection for electrical power to operate the electronic lock assembly 16 can be simplified and/or can avoid the need to handle the movement of the interface between the door frame 18 and the self-storage door 14.

This can similarly reduce the burden of installation and/or maintenance in applying the electronic lock assembly 16, whether to new facilities or in existing facilities that may be changing or adding locking systems, and/or may be newly integrating electronic locking systems. These benefit can be particularly important for large self-storage facilities which may have hundreds or thousands of self-storage units, and/or which may face issues for locking system changes, for example, due to the individualized nature of many of the self-storage unit lease agreements which may require specific timing for change of locking systems according to the rights and/or obligations of the tenant and/or landlord.

However, the benefits to providing electrical power access can be challenging to realize within the context of the self-storage environment. For example, the spatial constraints at the door frame can be highly restrictive, and/or the infrastructure of the facility itself can create burdens to the physical environment, increasing the difficulty of obtaining the appropriate space for reliable and/or cost-effective locking techniques.

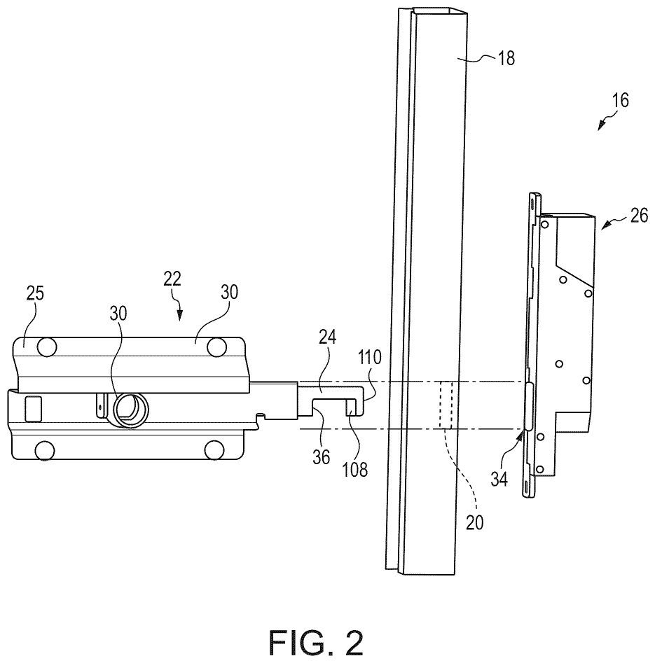

Referring now to FIG. 2, the electronic lock assembly 16 is shown exploded (laterally) in partial isolation other than the door frame 18 for illustrative ease. The hasp assembly 22 is embodied as a manual assembly allowing movement of the hasp 24 by the user's hand via handle 30. The hasp 24 is illustratively moveable between an extended position, as shown in FIG. 2, projecting out from the housing 25 of the hasp assembly 22 for engagement with the hasp retention assembly 26 through the opening 20 in the door frame 18 to block against movement of the self-storage door 14 out from the closed position (locking), and a retracted position withdrawn from the hasp retention assembly 26 and the door frame 18 to allow movement of the self-storage door 14 towards the open position (unlocking) for access to storage. The door frame 18 provides physical restriction to movement of the self-storage door 14 when the hasp 24 extends therethrough, with the hasp retention assembly 26 and the retention control system 28 operating to retain or release the hasp 24 from the extended position.

As suggested in FIG. 2, in the closed position of the self-storage door 14, the hasp 24 is arranged aligned with the opening 20 of the door frame 18 and a hasp passageway 34 of the hasp retention assembly 26. In the illustrative embodiment, the hasp 24 is formed from a rigid flat bar, and defining a notch 36 therein for engagement with the hasp retention assembly 26 as locking, as discussed in additional detail herein. The hasp 24 illustratively extends linearly with alignment vertically, laterally, depth-wise, and with sufficient angularity to insert through the opening 20 and into the hasp passageway 34. Accordingly, the tenant can manually slide the hasp 24 into locking engagement for retention by the hasp retention assembly 26.

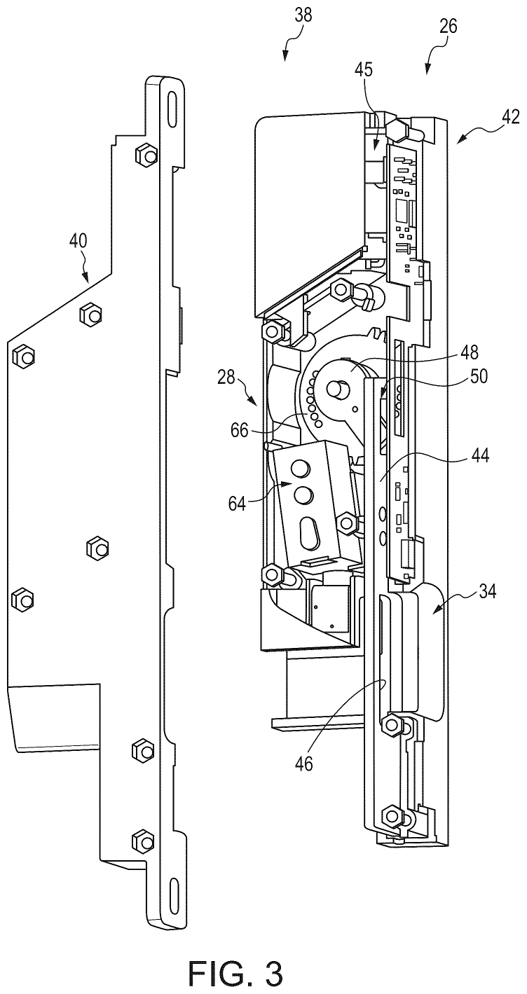

Referring now to FIG. 3, the hasp retention assembly 26 is shown partly exploded for ease of depiction. The hasp retention assembly 26 includes a frame 38 illustratively defining portions 40, 42 which collectively define a rigid body for mounting to the door frame 18, and which define a cavity 45 therein for housing components. The hasp retention assembly 26 includes a latch plate 44 arranged for movement between unlatched and latched positions to selectively engage with the hasp 24.

The latch plate 44 is illustratively formed as a flat plate and defines a hasp opening 46 which can define a portion of the hasp passageway 34 in the unlatched position, as suggested in FIG. 3. The latch plate 44 illustratively engages with a pivot key 48 for driven movement between latched and unlatched positions. The latch plate 44 illustratively includes a key opening 50, embodied as a longitudinal slot, for receiving the pivot key 48 at least partly therein for engagement.

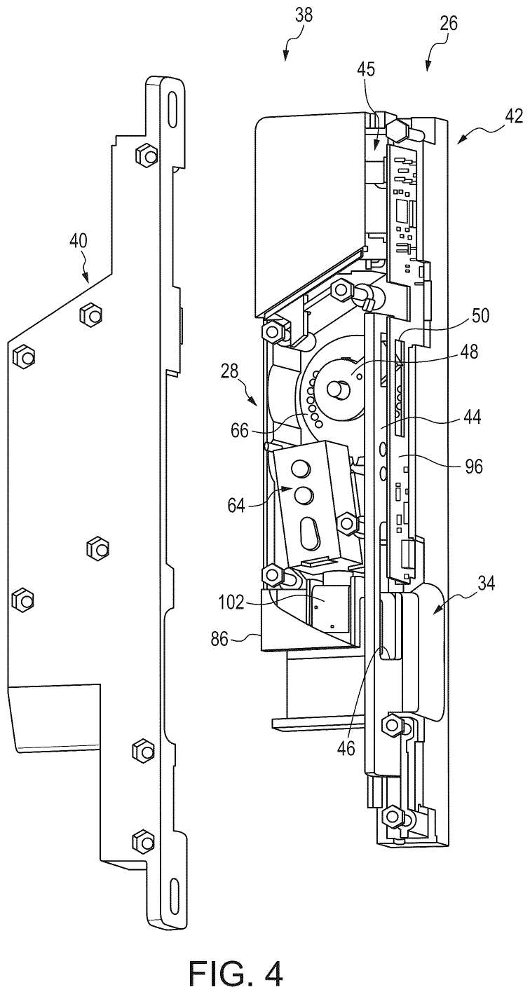

The latch plate 44 can be moved into a latched position, as suggested in FIG. 4, under drive from the pivot key 48 as discussed in additional detail herein. In the latched position of the latch plate 44, the hasp opening 46 is arranged (at least partially) out of alignment with the remainder of the hasp passageway 34. The misalignment allows the latch plate 44 to engage with the hasp 24 to block against movement of the hasp 24 out from the hasp passageway 34, and thus acting to block against movement of the self-storage door 14 out from the closed position. The pivot key 48 illustratively rotates under force from the retention control system 28 for selective retention of the hasp 24.

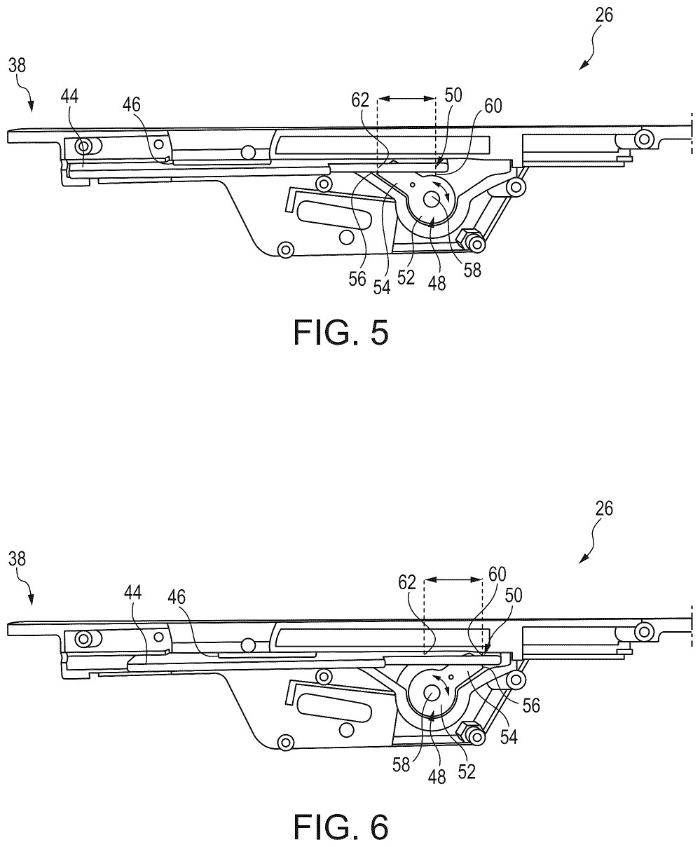

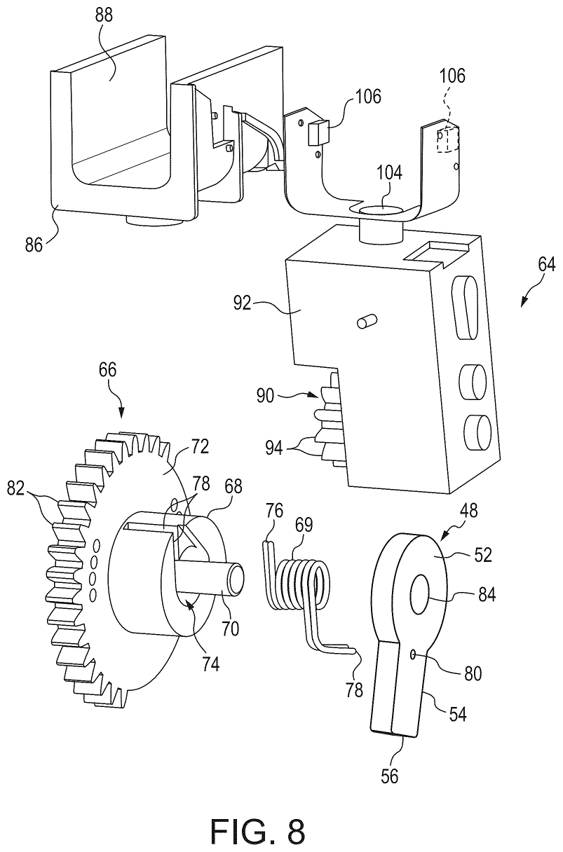

Referring to FIGS. 5 and 6, the latched (FIG. 6) and unlatched (FIG. 5) positions of the latch plate 44 are shown to illustrate the corresponding position of the pivot key 48. The pivot key 48 includes a body 52 and arm 54 projecting radially from the body 52 for engagement with the latch plate 44. The arm 54 defines an abutment surface 56 (see also FIG. 8) illustratively formed on a radially outward side thereof.

The pivot key 48 is selectively moveable between restricted (FIG. 6) and unrestricted (FIG. 5) positions. In the illustrative embodiment, the pivot key 48 rotates or pivots about an axis 58 swinging the arm 54 accordingly. The arm 54 extends to engage with the latch plate 44. The arm 54 illustratively inserts at least partly within the key opening 50 which is illustratively sized to allow smooth transition of the rotational movement of the arm 54 into movement of the latch plate 44.

As shown in FIG. 6, in the restricted position of the pivot key 48 which corresponds with the latched position of the latch plate, the abutment surface 56 of the pivot key 48 is aligned with an end face 60 of the key opening 50. If the latch plate were attempted to be moved out from the latched position towards the unlatched position (illustratively slid leftward, in the orientation of the embodiment as suggested in FIG. 6), the end face 60 would abut the abutment surface 56. The latch plate 44 and pivot key 48 are arranged such that abutment between the end face 60 and the abutment surface 56 under such attempted latch plate movement drives a force radially into the pivot key 48, e.g., towards the axis 58. This radial force does not cause rotation of the pivot key 48, but rather establishes a blocking force against movement of the latch plate 44 out from the latched position.

In the illustrative embodiment, the corresponding latched position of the latch plate 44 and restricted position of the pivot key 48 allows a small gap between the end face 60 and the abutment surface 56, although in some embodiments, contact between the end face 60 and the abutment surface 56 may be permitted in those corresponding positions with low enough force to allow rotation of the pivot key 48 for unlocking, as discuss in additional detail herein. In the illustrative embodiment, the end face 60 is arranged generally vertically in the orientation of FIGS. 5 and 6, and the abutment surface 56 is angled relative to the vertical in the restricted position; however, in some embodiments, the end face 60 may be angled complementarily to the abutment surface, and/or other suitable complementary shapes and/or forms of the end face 60 and abutment surface 56 may be applied, e.g., rounded, angled, and/or otherwise.

The pivot key 48 can be selectively rotated from the restricted position (FIG. 6) towards the unrestricted position (FIG. 5). The latch plate 44 and the pivot key 48 are arranged relative to each other such that rotation of the pivot key 48 towards the unrestricted position allows the abutment surface 56 to pass out of alignment with the end face 60. Once clearing the end face 60, further rotation of the pivot key 48 towards the unrestricted position engages the arm 54 with an opposite end face 62 of the key opening 50 for driving the latch plate 44 towards the unlatched position. Similarly, the pivot key 48 can be selectively rotated from the unrestricted position (FIG. 5) towards the restricted position (FIG. 6) to drive the latch plate 44 towards the latched position. In the illustrative embodiment in which the latch plate 44 moves generally linearly between latched and unlatched positions, the relation between the latch plate 44 and the pivot key 48 as tangential or secantial with only minor overlap in the rotational circumference of the abutment surface 56 (e.g., less than midline secant relative to the circumferential path) can allow the pivot key 48 to selectively rotate out from the restricted position, while the restricted position of the pivot key 48 blocks movement of the latch plate 44 out from the latched position. In the restricted position of the pivot key 48, the angle of the arm 54 relative to the attempted motion of the latch plate 44 out from the latched position can permit the resultant force onto the pivot key 48 to be radially directed for blocking.

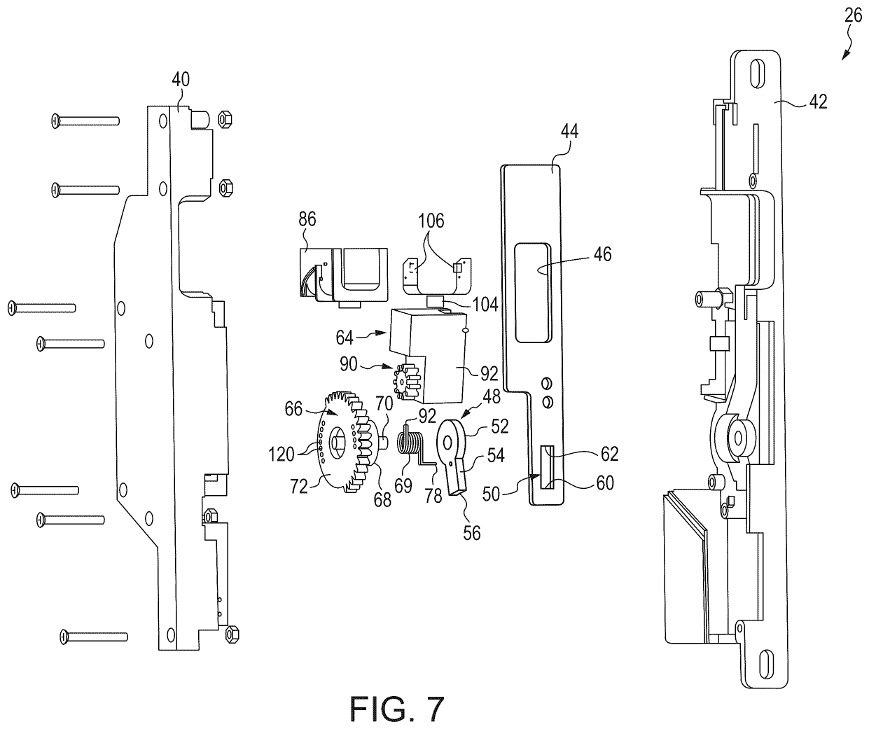

Referring to FIG. 7, components within the cavity 45 of the frame 38 are shown partially exploded for ease of depiction. An actuator 64 and gear 66 of the retention control system 28 are arranged to provide selective movement of the pivot key 48. The gear 66 is illustratively coupled with the pivot key 48 to transfer rotational force (torque) from the actuator 64 to the pivot key 48.

In the illustrative embodiment, the gear 66 and pivot key 48 are resiliently coupled via a spring 69 for rotational force. Referring to FIG. 8, the gear 66 includes a hub 68 and shaft 70 each projecting axially from a gear body 72, and defining a receiver 74. The spring 69 is illustratively embodied as a torsion spring, coiled between opposite ends 76, 78.

The spring 69 is illustratively mounted onto the shaft 70 and received within the receiver 74 of the hub 68. One end 76 of the spring 69 illustratively projects radially and engages with circumferentially facing surface(s) 78 of the hub 68 defining portions of the receiver 74 to transfer rotational force between the gear 66 and the spring 69. Another end 78 of the spring 69 projects axially, offset relative to the shaft 70 and inserts within an opening 80 of the pivot key 48, spaced apart from the axis 58 (as suggested in FIGS. 5 and 6).

The resilient connection between the gear 66 and the pivot key 48 can act to buffer rotational force from the actuator 64 to the pivot key 48. Such resilient actuation can avoid binding which can be generated from the cross-mixing of movement axes between the hasp 24 and the hasp retention assembly 26, including those binding forces which, for example, can be generated from variations in the position of the self-storage door 14 relative to the door frame 18, in the extension of the hasp 24, and/or in other positions. Self-storage doors can undergo significant variation in their positioning even in the closed position, for example, due to allowable tolerance in their track operation. Accordingly, such variations can be accommodated even with suitable electronic lock assembly operation.

Still referring to FIG. 8, the gear 66 illustratively includes teeth 82 projecting from the gear body 72 for coupling with the actuator 64 to receive drive force. The shaft 70 extends from lateral sides of the gear body 72 for connection with the frame 38 to support the gear 66 for rotational movement. The pivot key 48 is illustratively mounted onto the shaft 70 by insertion through an opening 84. It can be appreciated in the illustrative embodiment, that the shaft 70 is coaxial with the axis 58 of rotational movement of the pivot key 48, although in some embodiments additional linkage can allow the pivot key 48 and gear 66 to be non-coaxial.

The actuator 64 is illustratively embodied as an electrical rotatory actuator having a drive wheel 90 coupled with a body 92 via a shaft which is selectively driven by components within the body, illustratively embodied to include a dc motor. Rotation of the shaft by the motor rotates the drive wheel 90 which includes teeth 94 formed complementary for engagement with the teeth 82 of the gear 66 to transfer rotational force. Actuator operation is illustratively governed by a controller 96 of the retention control system 28, which illustratively is embodied as a control board including processor 118 for executing instructions stored on memory 120, and communications circuitry 122 for conducting communications in accordance with commands of the processor (as suggested in FIG. 10).

As suggested in FIGS. 4, 7, and 9, the hasp retention assembly 26 includes a hasp casing 86 defining an additional portion of the hasp passageway 34, which is aligned with the portion of the hasp passageway 34 defined by the frame 38, and the portion of the hasp passageway 34 defined by the hasp opening 46 of the latch plate in the unlatched position. The hasp casing 86 provides additional surface area for guiding engagement of the hasp 24 within the hasp passageway 34 within the frame 38.

As suggested in FIG. 8, the hasp casing 86 is illustratively formed to have a u-shape with interior surface 88, complementary with interior surfaces of the frame 38 to collectively provide a smooth engagement for guiding the hasp 24. A sensor system mount 102 is arranged closely with the hasp casing 86 for assisting in determining the presence of the hasp 24 within the hasp passageway 34.

The sensor system mount 102 illustratively includes a u-shaped support formed complementary with the hasp casing 86. A magnet 104 is illustratively arranged at a middle lower end of the mount 102, and sensors 106 of the retention control system 28 are each coupled with the mount 102 at either ends of the u legs. In the illustratively embodiment, the magnet 104 is arranged to generate a magnetic field within the hasp passageway 34 such that upon entry of the hasp 24 into the hasp passageway in the extended position, the magnetic field is disrupted. The sensors 106 are arranged relative to the magnet 104 and hasp passageway 34 to sense the disturbance in the magnetic field such that the retention control system 28 can determine whether or not the hasp 24 is within the hasp passageway 34. The sensors 106 are illustratively arranged on opposite sides of the hasp passageway 34 offset from the lower extent thereof near the middle of the hasp passageway 34.

In the illustrative embodiment, responsive to determination that the hasp 24 is within the hasp passageway 34, the retention control system 28 can operate the latch plate 44 to move into the latched position to block against movement of the hasp 24 out from the extended position within the hasp passageway 34, as locking. Such automatic operation can permit the hasp retention assembly 26 to remain securely behind the walls of the self-storage unit/facility, within the door frame 18 and behind the self-storage door 14.

As discussed in additional detail herein, operation for unlocking can be achieved by wireless communication with a personal mobile device (or equivalent keyfob, tag, or remote devices), and can reduce or remove the need for additional local control panels. Such aspects can reduce the complexity and/or burden to installation, for example, by reducing and/or removing the need for additional penetrations and/or cabling through walls or other structures to communicate with the hasp retention assembly 26.

Such automatic operation can benefit from the resilient connection between the actuator 64 and the pivot key 48. For example, if the hasp 24 is poorly positioned but within the hasp passageway 34 such that automatic locking is attempted, but the notch 36 of the hasp 24 is not quite aligned with the hasp opening 46, as discussed in additional detail herein, to effect locking, the continued drive of the pivot key 48 to attempt locking could damage components, strain the actuator, and/or cause binding or jamming, yet the resilient connection allows the pivot key 48 to be attempted for rotation towards the restricted position while absorbing when the pivot key 48 is prevented by such misaligned, which can reduce and/or avoid such damage issues. Under such instances, in some embodiments, the actuator can be automatically operated to reverse and re-attempt for limited number of times before time out responsive to high loading.

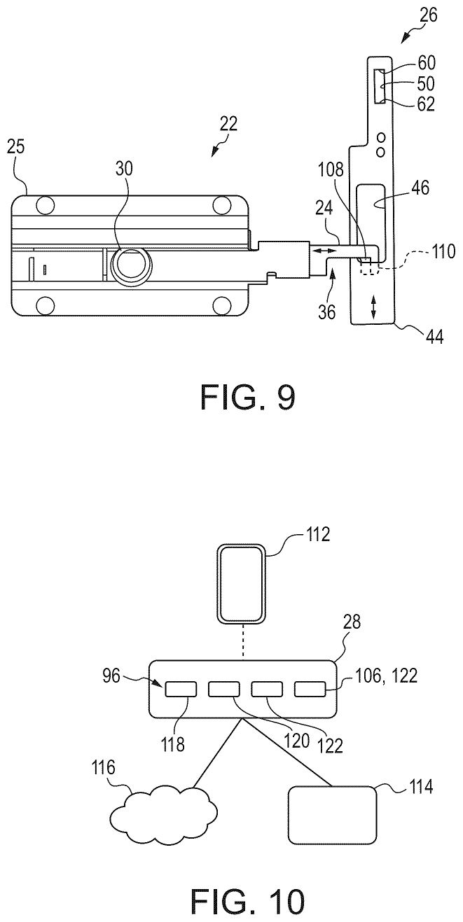

Referring now to FIG. 9, engagement between the hasp assembly 22 and the hasp retention assembly 26 as locking is illustrated with portions of the hasp retention assembly 26 omitted other than the latch plate 44. With the hasp 24 in the extended position within the hasp passageway 34, the notch 36 is arranged to correspond in lateral position (relative to FIG. 9) with the hasp opening 46 of the latch plate 44. As shown in FIG. 9, the latch plate 44 has been moved towards its restricted position (upward in the orientation of FIG. 9), such that the latch plate 44 and the hasp 24 laterally abut each other under attempt retraction of the hasp 24 towards the retracted position. Namely, a face 108 of a head 110 of the hasp 24 and an opposing surface 182 of the latch plate 44 can abut each other under attempted retraction of the hasp 24 towards the retracted position, blocking against movement of the hasp 24 out from the extended position as locking. In the illustrative embodiment, the hasp opening 46 is embodied as a penetration having closed circumferential extent defined by the latch plate 44; although in some embodiment, the hasp opening 46 may have any suitable form, including open circumferential extent, for example, having the actuation on the lower end (e.g., key opening 50, and pivot key 48 arranged below the hasp opening 46) or the notch 36 being defined on a topside of the hasp 24, and the hasp opening 46 defined by an open edge end of the latch plate 44.

Referring now to FIG. 10, the retention control system 28 is illustratively arranged in communication with various systems and/or devices. For example, as previously mentioned, the retention control system 28 can illustratively communicate with a personal mobile device 112 of a local user, such as a tenant accessing the storage unit, to receive wireless commands for unlocking (and in some embodiments, for locking). The retention control system 28 is illustratively arranged in communication with facility devices and/or systems such as servers 114, and/or with networks 116. In the illustrative embodiment, the network 116 is embodied as the internet, e.g., IIOT, and can communicate with other communication networks such as mobile networks, for example, to send and/or receive information such as lock status (state of locking/unlocking), time of access, etc. in exchange for access by users, such as tenants and/or landlords. In the illustrative embodiment, the server 114 is a dedicated server of the facility, but in some embodiments, may be related servers of multiple facilities. In some embodiments, the mobile device may be arranged in communication with the retention control system 28 via network 116, e.g., via wireless communications network such 3G/4G/5G networks and/or via WiFi or other local area network.

As suggested in FIGS. 4 and 7, the portions 40, 42 of the frame 38 are illustratively coupled together by bolts inserted through each portion 40, 42 having a bolt head on one side, and secured with a nut on the other side. The nut is illustratively recessed in complementary opening formed on the exterior side of the portion 40, although reverse orientation of the bolts/nuts can be applied. In some embodiments, the bolt may be secured by threading directly into the other portion 40, 42. Referring to FIG. 7, the gear 66 illustratively includes magnet holes 120 for receiving a magnet mounted therein such that a sensor 122 of the retention control system (FIG. 10) is arranged to detect the presence/absence of the magnet to determine the position of the gear between rotational extents thereof. The retention control system 28 can govern operation of the actuator 64 based on detection of the amount of rotation of the gear 66. For example, upon detection of an end of rotational extent of the gear 66 during rotation, the retention control system can control the actuator 64 to stop rotation (i.e., motor stop).

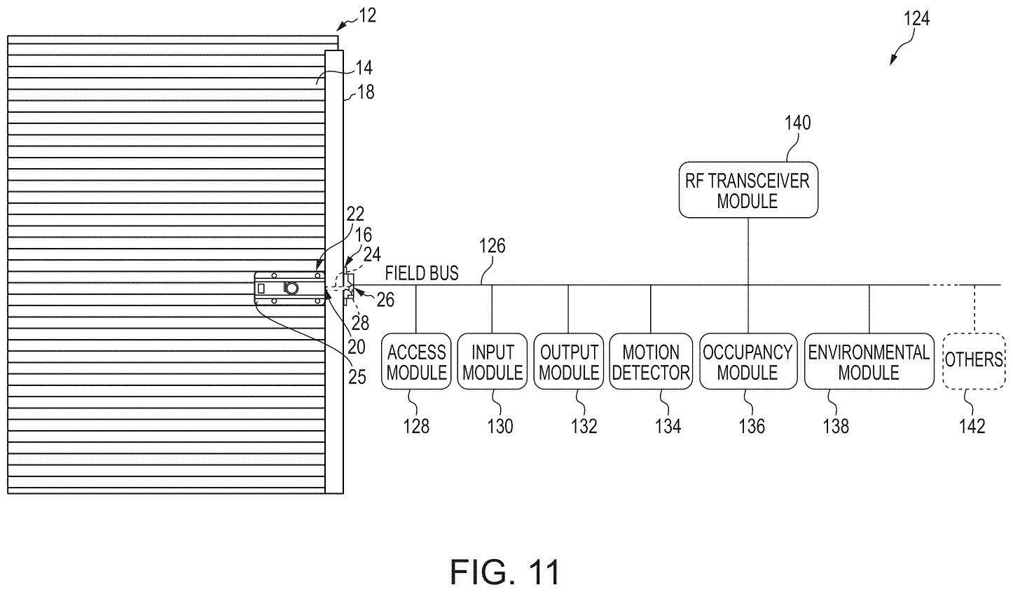

Referring now to FIG. 11, the electronic self-storage locking system 12 having the electronic lock assembly 16 coupled with a Nokē bus assembly embodied as a field bus assembly 124. The field bus assembly 124 illustratively includes a bus 126 and a number of operational modules 128-142. The bus 126 is configured to provide communication between the modules 128-142 and the electronic lock assembly 16 to implement one or more of the modules 128-142 as a portion of the retention control system 28 for governing operation.

In the illustrative embodiment, the bus 126 is formed as a wired bus connected with the electronic lock assembly 16 and one or more of the modules 126-142. The bus 126 provides data communication between the electronic lock assembly 16 and one or more of the modules 126-142, and can optionally provide electrical power to one or more of the modules 126-142, whether by separate electrical connection and/or as integrated data/power such as by power over Ethernet (POE). In some embodiments, the bus 126 may include wireless communications between the electronic lock assembly 16 and one or more of the modules 126-142, including wireless communications with all modules, or including wired communications with one or more modules and wireless communications with other modules.

The field bus assembly 124 illustratively includes an access module 128 for facilitating user access to self-storage. In the illustrative embodiment, the access module 128 can provide for local wireless communications to support unlocking (and in some embodiments, locking). For example, the access module 128 can provide a communications hardware and/or software/firmware to support communications with a user's (e.g., tenant's) personal mobile device. This can be in additional and/or complementary to functionality of the communications circuitry of the retention control system 28. The access module 128 is illustratively embodied as multi-protocol enabling including Near Field Communication (NFC), HID tag/card, Ultra-Wideband (UWB), and Bluetooth, among other wireless local communications; although in some embodiments, may comprises greater or fewer types of communication versatility. The NFC functionality is illustratively configured for receiving wireless energization (electrical power) to the electronic lock assembly 16, namely the retention control assembly 28, to support unlocking of the electronic lock assembly 16, for example, under blackout in which local power infrastructure is unavailable; and in some embodiments, for receiving wireless energization (electrical power) to the electronic lock assembly 16 for locking the electronic lock assembly 16. The Ultra Wide Band functionality of the access module 128 illustratively facilitates automatic unlocking and/or locking of the electronic lock assembly 16. For example, the access module 128 via UWB functionality illustratively can detect the presence of the user (e.g., tenant) with a UWB tag nearby (e.g., within 1-3 feet) of the module 128, for example, standing in front of the self-storage unit and can determine to cause unlocking, and can communicate with the other retention control system 28 features to cause automatic unlocking of the electronic lock assembly 16 in response to such determination; although in some embodiments, determination may be conducted by processor 118 based on detection from the module 128. In the illustrative embodiment, the access module 128 via UWB functionality illustratively can detect the lack of presence of the user (e.g., tenant) with a UWB tag nearby (e.g., not within 1-3 feet) of the module 128, for example, standing in front of the self-storage unit and can determine to cause unlocking, and can communicate with the other retention control system 28 features to cause automatic locking of the electronic lock assembly 16 in response to such determination; although in some embodiments, determination may be conducted by processor 118 based on detection from the module 128. In some embodiments, automated locking and/or locking via the access module 128 may be toggled as an option in advance by the user, for example, via a program interface available via a computer network. Tags/cards, such as UWB or HID tags/cards, may be distinct device tags or may be embodied by a user's personal mobile device.

The field bus assembly 124 illustratively includes an input module 130 and an output module 132 each for communication with 3^{rd} party systems, e.g., security systems, building automation systems, and the like. Each of the input and output modules 130 can generally facilitate communications between the 3^{rd} party systems and the retention control system 28. In some embodiments, the input and output modules 130, 132 may be formed as a shared module for input/output operations.

The field bus assembly 124 illustratively includes a motion detector module 134 for detecting motion. The motion detector module 134 can include motion sensors and/or other peripherals for detecting motion in and/or around the self-storage unit. In the illustrative embodiment, the motion detector module 134 can detect motion and determine threshold motion for communication to the control board of the retention control system 28; but in some embodiments, detection may be conducted by the motion detector module 134 for communication to the control board for determination of threshold motion for operation.

The field bus assembly 124 illustratively includes an occupancy module 136 for detecting occupancy within the unit. The occupancy module 136 can include conditions sensors (e.g., motion, heat, activity, number of occupants, position (standing/sitting/laying down) and/or other) and/or other peripherals for detecting occupancy within the self-storage unit. In the illustrative embodiment, the occupancy module 136 can detect conditions (e.g., motion, heat, activity, number of occupants, position and/or other) within the self-storage unit and determine threshold conditions of occupancy for communication to the control board of the retention control system 28; but in some embodiments, occupancy condition detection may be conducted by the occupancy module 136 for communication to the control board for determination of threshold occupancy for operation. For example, detection of motion, number of occupants, body position, heat (thermometer, infrared), humidity, by combination of threshold static values, threshold variations over time, time of day, year, month, lock status (locked or unlocked), and/or other suitable comparison threshold information (as occupancy conditions), can be applied to determine whether occupancy of the self-storage unit exists. Such occupancy monitoring can assist in general activity monitoring and/or in specific self-storage issues, such as undesirable trapping of a person (whether due to accident or injury, or simply mistaken locking) or undesirable habitation within a self-storage unit. In some embodiments, pattern recognition may be applied to determine whether undesirable occupancy exists, for example, by entry of occupancy conditions into a machine learning model, trained to output determination of whether undesirable trapping or habitation within a self-storage unit exists. Such a machine learning module can include one or both of random forest and XGBoost, although in some embodiments, any suitable manner of model may be applied, for example but without limitation, supervised, quasi-supervised, and/or unsupervised learning models, such as linear regression, logistic regression, decision tree, SVM, Naive Bayes, kNN, k-means, dimensionality reduction algorithms, gradient boosting algorithms (e.g., GBM, LightGBM, CatBoost) style models. Such machine learning modules may be implemented as software and/or firmware executed on processor, whether of processor 118 of the retention control system 28, and/or by processor coupled in communication by network or otherwise. The occupancy module 136 can comprise infrared (IR), microwave, millimeter ware (mmWave), video recognition, hardware and/or software/firmware for facilitating operations; and in some embodiments, accuracy and/or reliability of the detection/determination may be enhanced by incorporation of two or more of the above-mentioned technologies.

The field bus assembly 124 illustratively includes an environmental module 136 for detecting environmental conditions, such as temperature, humidity, wind speed, barometric pressure, particulate (dust and/or smoke detection), etc. Such environmental conditions can be detected apart from other modules, and/or partly or wholly in combination with other modules. Responsive to threshold values, for example, threshold hot/cold, humidity, smoke/dust, the module 136 can cause communication to attendant, such as a site manager for attention.

The field bus assembly 124 illustratively includes an wireless module 140 for assisting with wireless communications. In the illustrative embodiment, the wireless module 140 is embodied as a radio frequency (RF) transceiver module for facilitating wireless communications between the retention control assembly 28 and other systems, and is implemented in conjunction with communications circuitry 122; although in some embodiments, wireless module 140 may be arranged for separate communications from the communications circuitry. In the illustrative embodiment, the wireless module 140 is configured to extend wireless coverage to communicate with back-end wireless communications systems, to improve wireless performance, minimize dead spots across a self-storage facility, and/or to reduce the need for wireless repeaters.

The field bus assembly 124 may include one or more other modules 142 which may implement additional features and/or functionality. Accordingly, the field bus assembly 124 can be an expandable field bus assembly 124, such that the bus 126 can be configured to accept additional modules by expansion for communication as a portion of the retention control system. One other module may include an indication module operable to provide the user (e.g., tenant) with the visual and/or audio status indication of the electronic lock assembly 16, for example, the indication motion may include an LED light module which can change between colors (e.g., green, red) to indicate lock status and/or character screen to indicate locked vs. unlocked by text or image. Another other module may include a 3^{rd} party access module operable to integrate operation of the electronic lock system 16 with access (unlocking/locking) from 3^{rd} party control systems and/or building automation systems.

Still referring to FIG. 11, another exemplary module of the other modules 142 can include a self-storage space camera configured to provide still frame and/or video image of the storage space within the self-storage unit enclosed by the self-storage door 14. In the illustrative embodiment, the camera module can be activated as a security video record in response to detection of break in to the self-storage unit, for example, by detection of forced entry upon the lock or door itself. In some embodiments, the camera module may be motion activated responsive to movement within the storage unit, and may include video stored in a backend cloud server via the network. In the illustrative embodiment, the camera module is configured for capturing still images. In response to a user activation, the camera module can capture still image of the self-storage space within the self-storage unit. The user can activate capture of still image by selection of a user interface button on a personal mobile device 112, for example, via an app, causing responsive transmission of a request for still image via the network, and can receive transmission of the still image from the control system to the personal mobile device 112 via the network.

Still another module of the other modules can include an audio module. The audio module is illustratively embodied as configured to provide 2-way intercom service to allow a user local to the self-storage unit to send and receive audio transmissions via the network. For example, a local user can communicate via the 2-way intercom with a central control room. In the illustrative embodiment, the audio module includes a transmit button operable to capture audio via a microphone and to transmit the audio, and can receive audio transmission and play audio via a speaker for intercom operation. In some embodiments, a “hands-free” audio operation may be permitted to communicate between the local storage unit and a control room, for remote monitoring of break-in while the lock is secured in the lock position and/or for monitoring occupants while inside the unit, for example, for fall hazards or other emergencies.

Each of modules 128-142 are illustratively implemented by a combination of hardware and software and/or firmware, but in some embodiments, may comprise only hardware or only software and/or firmware implemented appropriately, for example, on separate processor and/or apart from bus 126 on control board 96. In the illustrative embodiment, the electronic lock assembly 16, and specifically, the hasp retention assembly and/or retention control system, is embodied to operate using hardwired power as a primary electrical power source; however, in some embodiments, a local battery storage system may be applied to provide temporary backup power, and/or as primary power for replacement and/or recharging.

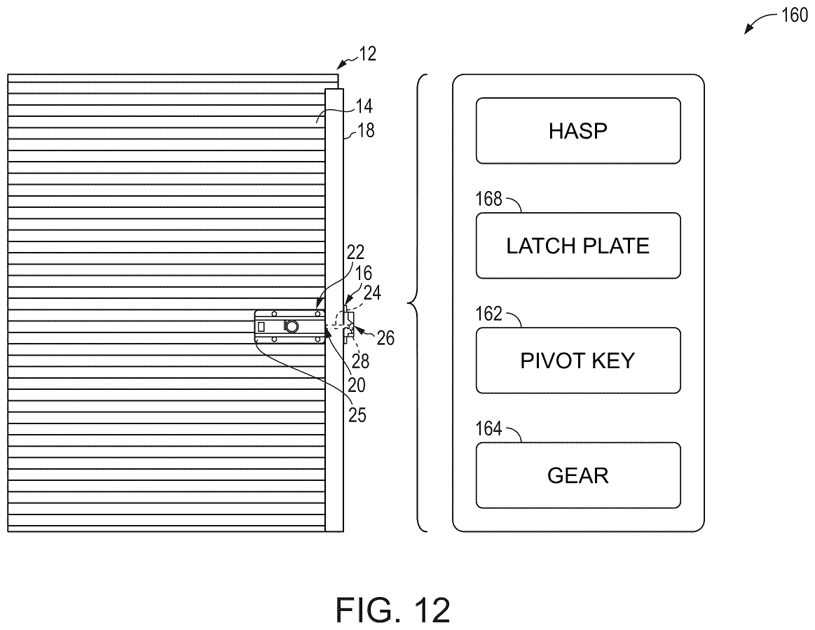

Referring now to FIG. 12, the retention control system 28 illustratively includes a sensor system 160 for supporting retention control system operations. Particular coordination and/or control in coordination of the sensor system 160 can enhance operation of the electronic lock assembly, for example, by enhancing certainty of conditions and/or additional resolution of multivariable conditions to determine jamming and/or remedial options.

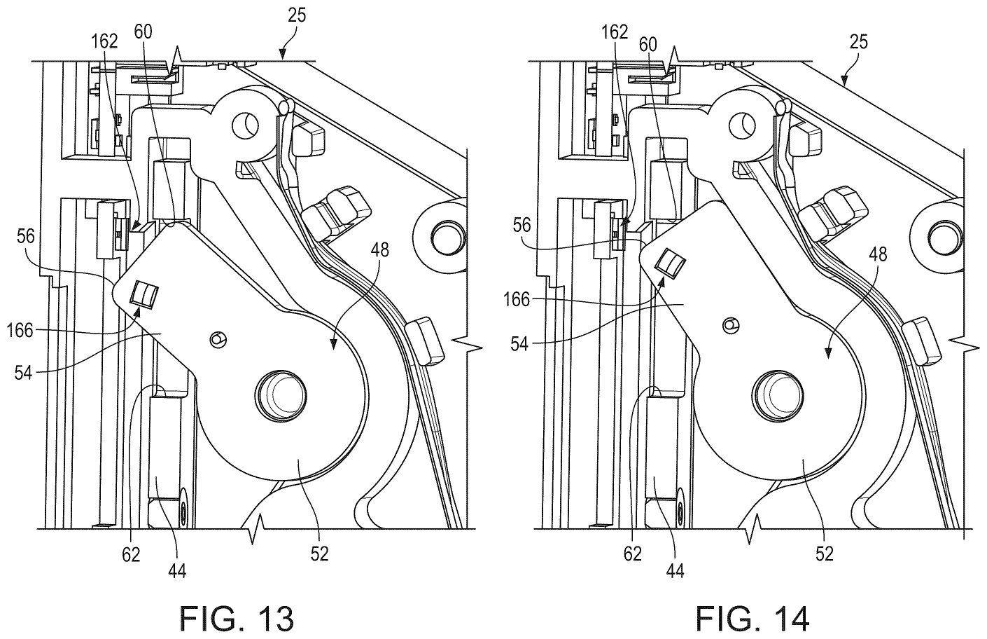

In the illustrative embodiment as shown in FIGS. 13-16, the sensor system 160 includes a pivot key sensor 162 configured to sense positioning of the pivot key 48 and a gear sensor 164 configured to sense positioning of the gear 66. The retention control system 28 can determine precise operation of the electronic lock system based on sensed position of the pivot key 48 and gear 66. For example, a disagreement between the sensed positions of the pivot key 48 and the gear 66 can be applied to determine whether jamming occurs. In some embodiments, the sensor system 160 may include sensors 106 and/or other sensors.

As shown in FIGS. 13 and 14, the pivot key 48 is arranged seated for secure locking in a closed position (corresponding with its restricted position) to close the latch plate 44 in FIG. 14, and in FIG. 13 the pivot key 48 is unseated from the closed position but close to the closed position illustratively as a result of jamming. In the particular instance of FIG. 13, the pivot key 48 is partly contacting the latch plate 44, restricting the ability of the pivot key 48 to achieve full seating in the closed position. More specifically, a distal end of the arm 54 near the abutment surface 56 is in partial contact with the latch plate 44 near the end face 60 which may cause blocking or otherwise cause enough friction to prevent the pivot key 48 from fully seating in the closed position, illustratively indicated as about 15 degrees of rotation from seating in the closed position although other interim positions may apply. In such an intermediate position of the pivot key 48, the latch plate 44 is not completely positioned in its latched position, although the latch plate 44 may be sufficiently close to its latched position to block against movement of the hasp 24 out from the extended position. The sensor system 160 can assist in achieving fully secure locking.

In FIG. 14, the pivot key sensor 162 illustratively senses the pivot key 48 positioned in the closed position. By comparison, in FIG. 13, the pivot key sensor 162 senses the pivot key 48 not positioned in the closed position, illustratively by not sensing affirmative confirmation of the closed position. As discussed in additional detail herein, the retention control system 28 can determine jamming upon detection that the pivot key 48 is not within the closed position while the gear achieves a closed position corresponding with the latched position of the latch plate 44.

In the illustrative embodiment, the pivot key sensor 162 is embodied as a hall effect sensor arranged on the control board 96. The pivot key 48 illustratively includes a magnet 166 arranged to provide magnetic field for sensing by the pivot key sensor 162 when the pivot key 48 is in the closed position. The magnet 166 is illustratively embodied as a cylindrical magnet arranged to extend between its poles at an angle relative to the extent of the arm 54 from the body 52 of the pivot key 48. The magnet 166 is arranged on the arm 54 with orientation of one of its pole ends directed towards the pivot key sensor 162 when the pivot key 48 is in the closed position such that is magnetic field is emphasized towards the pivot key sensor 162. When the pivot key 48 is not in the closed position, such as in FIG. 13, the magnet 166 is oriented such the pole end is misdirected from the pivot key sensor 162 to deemphasize magnetic field towards the pivot key sensor 162. In the illustrative embodiment, outside of the closed position of the pivot key 48, the pole end does not face directly towards the pivot key sensor 162 such that weak or no magnetic field impacts the pivot key sensor 162.

As the pivot key 48 rotates between its open position (corresponding with its unrestricted position) and its closed position, the magnet 166 is moved along an arc path. In the closed position of the pivot key 48, the magnet 166 is illustratively positioned along the arc path closest to the pivot key sensor 162. Accordingly, in the closed position of the pivot key 48, the pivot key sensor 162 can sense the magnet by magnetic field to allow the retention control system 28 to determine that the pivot key 48 is in the closed position.

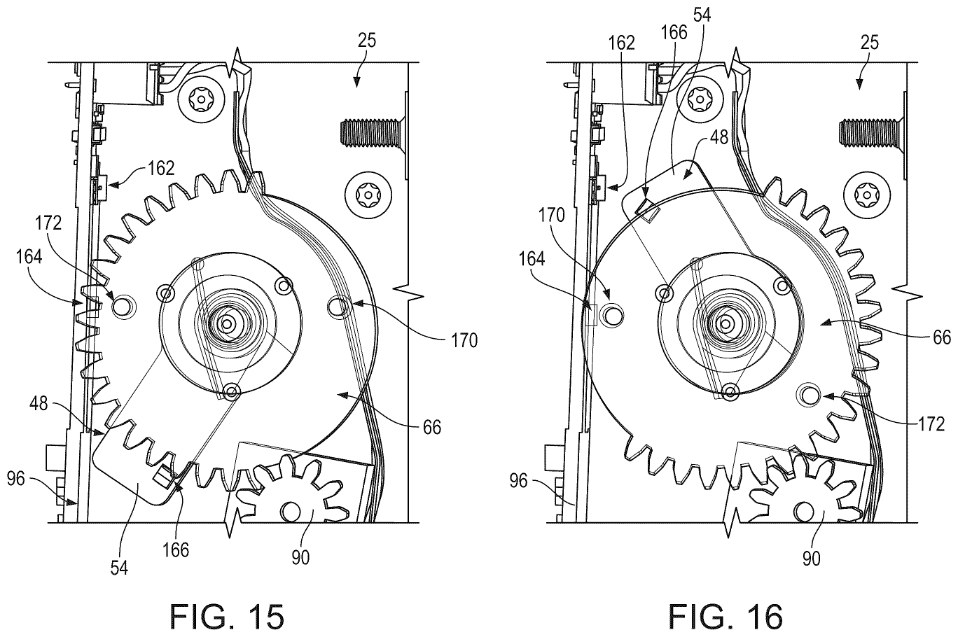

Referring now to FIGS. 15 and 16, the gear 66 is arranged in an open position (corresponding with encouraging the pivot key 48 towards the open position and the latch plate 44 towards the unrestricted position) in FIG. 15, and in FIG. 16 the gear is arranged in a closed position (corresponding with encouraging the pivot key 48 towards the closed position and the latch plate 44 towards the restricted position). In FIG. 15, the gear sensor 164 illustratively senses the gear 66 positioned in the open position. By comparison, in FIG. 16, the gear sensor 164 senses the gear 66 in the closed position. In the illustrative embodiment, the gear sensor 164 senses the open and closed positions of the gear 66 by affirmative sensing, and can sense lack of positioning in the open and closed positions by not sensing affirmative confirmation of position; and the retention control system can determine lack of open and/or closed positions accordingly. As discussed in additional detail herein, the retention control system 28 can determine jamming upon detection that the pivot key 48 is not within the closed position while the gear 66 achieves a closed position corresponding with the latched position of the latch plate 44.

In the illustrative embodiment, the gear sensor 164 is embodied as a hall effect sensor arranged on the control board 96. The gear 66 illustratively includes magnets 170, 172 arranged to provide magnetic field for sensing by the gear sensor 164 when the gear 66 is in the open and closed positions. An open magnet 170 is arranged on the gear body 72 near the outer circumference such that on rotation of the gear 66 into the open position the magnetic field of the open magnet 170 influences the gear sensor 164 to allow sensing of its presence for determination of open position of the latch plate 44 by the retention control system 28. A closed magnet 172 is arranged on the gear body 72 near the outer circumference (illustratively in a different circumferential position as the open magnet 170) such that on rotation of the gear 66 into the closed position the magnetic field of the closed magnet 172 influences the gear sensor 164 to allow sensing of its presence for determination of closed position of the latch plate 44 by the retention control system 28.

The magnets 170, 172 are each illustratively embodied as a cylindrical magnet arranged to extend between its poles parallel to the axis of rotation of the gear 66 but radially offset relative to the gear 66. When the gear 66 is in either open or closed position, the corresponding one of the open and closed magnets 170, 172 is arranged with influential proximity to the gear sensor 164 such that it is directed towards the gear sensor 164 to emphasize magnetic field towards the gear sensor 164. When the gear 66 is in neither open or closed position, neither magnet 170, 172 is arranged with influential proximity to the gear sensor 164 such that each are misdirected from the gear sensor 164 to deemphasize magnetic field towards the gear sensor 164.

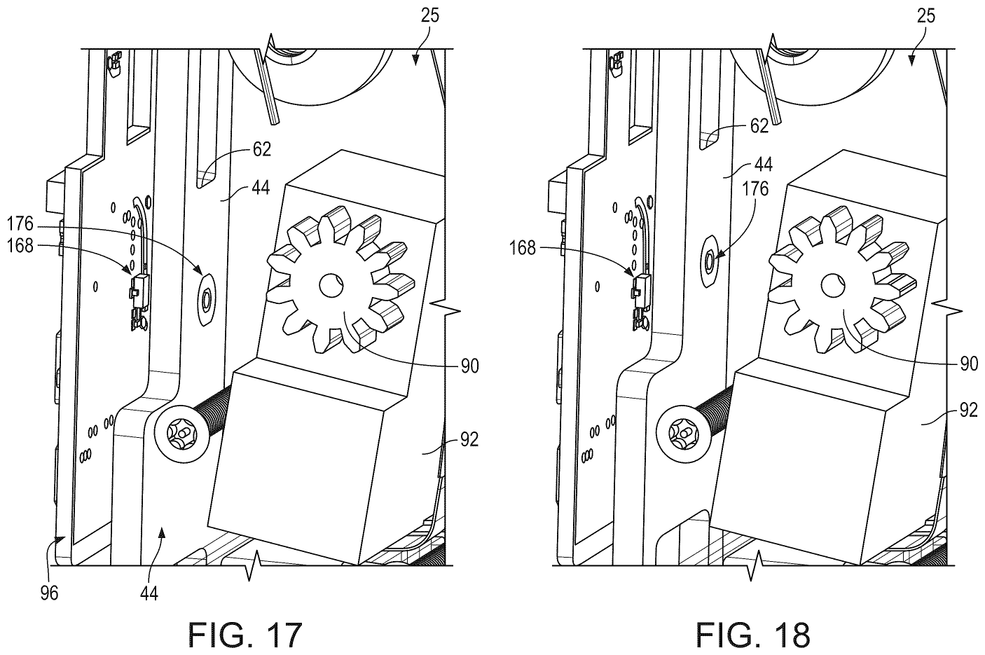

Referring now to the illustrative embodiment as shown in FIGS. 17 and 18, the sensor system 160 includes a latch plate sensor 168 configured to sense positioning of the latch plate 44. In the depiction of FIGS. 17 and 18, the gear 66 has been omitted for ease of viewing. The retention control system 28 can determine precise operation of the electronic lock system based on sensed position of the latch plate 44.

In the illustrative embodiment, the latch plate sensor 168 is embodied as a hall effect sensor arranged on the control board 96. The latch plate 44 illustratively includes magnet 176 arranged to provide magnetic field for sensing by the latch plate sensor 168 when the latch plate 44 is in the open position as shown in FIG. 17. The magnet 176 is illustratively embodied as a cylindrical magnet arranged to extend between its poles laterally relative to the latch plate 44. The magnet 176 is arranged on a body of the latch plate 44 with orientation of one of its pole ends directed towards the latch plate sensor 168 with the latch plate 44 is in the open position such that is magnetic field is emphasized towards the latch plate sensor 168. With the latch plate 44 not in the open position, such as in FIG. 18, the magnet 176 is oriented (illustratively translated upwards in the orientation of FIG. 18) such the pole end is misdirected from the latch plate sensor 168 to deemphasize magnetic field towards the latch plate sensor 168. In the illustrative embodiment, outside of the open position of the latch plate 44, the pole end of the magnet 176 is not directed towards the latch plate sensor 168 as embodied by arrangement vertically spaced apart (in the orientation of FIG. 18) from the latch plate sensor 168 such that weak or no magnetic field impacts the latch plate sensor 168.

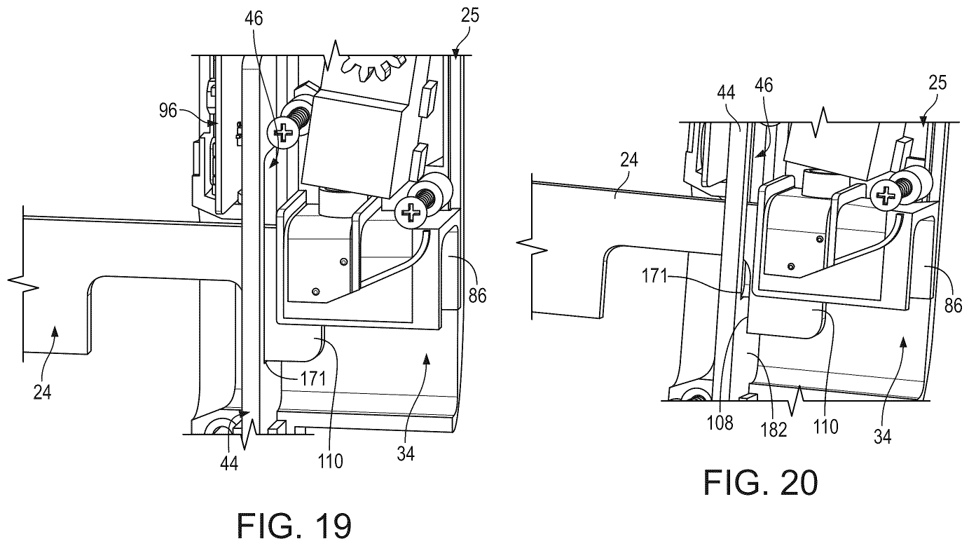

Referring now to FIGS. 19-21, the retention control system 28 can manage mis-operation such as jamming. Mis-operation can include unexpected positioning and/or response of components within the electronic lock assembly 16. As the illustrative embodiment includes manual sliding of the hasp 24 between extended and retracted positions, a user may mistakenly attempt to move the hasp 24 into the extended position for locking, but may fail to achieve full alignment between the notch 36 and the latch plate 44 to facilitate locking. For example, as suggested in FIG. 19, the hasp 24 is arranged incompletely seated within the extended position such that the notch 36 is not fully aligned with the latch plate 44 such that the head 110 of the hasp 24 blocking against the latch plate 44 from moving towards the latched position. In the illustrative embodimenhaspt as shown in FIG. 19, the head 110 is engaged on a lower end with a surface 171 of the hasp opening 46. Referring to FIG. 20, in another example, the hasp 24 has been moved towards the extended position, but the remains with the notch 36 incompletely aligned with the latch plate 44 such that friction and/or lateral forces between the surface 108 defining a portion of the notch 36 of the hasp 24 and a surface 182 the latch plate 44 block against the latch plate 44 moving entirely into the latched position. For sake of discussion, such example instances in which locking is obstructed can be referred to as locking restricted.

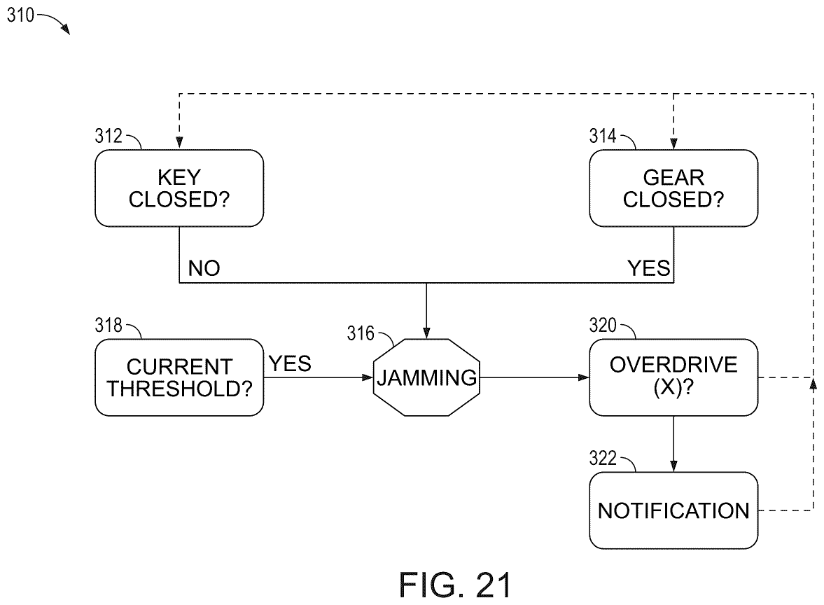

Referring now to FIG. 21, the retention control system 28 can manage mis-operation for locking restricted conditions. The retention control system 28 can determine jamming in operation 310. In the illustrative embodiment, in box 312, the retention control system 28 can determine whether the pivot key 48 is in the closed position. The retention control system 28 can detect the sensed position of the pivot key 48 from the pivot key sensor 162, and can determine whether the pivot key 48 is in the closed position, illustratively by affirmative sensing or lack thereof by the pivot key sensor 162.

In the illustrative embodiment, in box 314, the retention control system 28 can determine whether the gear 66 is in the closed position. The retention control system 28 can detect the sensed position of the gear 66 from the gear sensor 164, and can determine whether the gear 66 has achieved the closed position, illustratively by affirmative sensing or lack thereof by the gear sensor 164. In the illustrative embodiment, the direction of motor rotation is known according to the control instructions and together with the sensed position of the gear 66 can distinguish between open and closed positions according to the controller determination.

In the illustrative embodiment, in box 316, the retention control system 28 can determine whether jamming occurs. In response to both of: determination that the pivot key 48 is not in the closed position, and determination that the gear 66 has achieved the closed position, the retention control system 28 determines that jamming occurs. In the illustrative embodiment, because the pivot key 48 and the gear 66 are resiliently coupled, the achievement of a fully closed position for the gear 66 while the pivot key 48 does not achieve its closed position indicates that the latch plate 44 cannot reach its latched position downstream of the gear 66. In some embodiments, the retention control system 28 may consider whether an amperage or current (upper) threshold of the actuator 64 has been reached (box 318) and/or whether the latch plate 44 is determined to be in the open position according to the latch plate sensor 168.

In box 320, the retention control system 28 can apply overdrive to attempt to overcome the jam. For example, in the instance that friction and/or similar forces block components from achieving corresponding positions for locking, such as disclosed relative to FIGS. 13-14 and 20, the retention control system 28 can optionally apply overdrive. In the illustrative embodiment, the retention control system 28 can apply overdrive by increasing the power to the actuator beyond its normal locking operational power; by non-limiting example, normal operational power for locking may be 90% of rated power of the actuator 64 and overdrive may be 100% of rated power. Such overdrive operation may overcome threshold frictional type forces to allow locking, for example, to overcome rubbing of the hasp 24 against the latch plate 44 and/or to overcome contact between the pivot key 48 and the latch plate 44. In some embodiments, overdrive may be applied more than once, and in each instance, operations may return to consider positioning in boxes 312, 314, and responsive to continued determination of jamming in box 316, for example, to exceed a predetermined threshold number of attempts (e.g., 2 attempts), may proceed to box 322.

In box 322, the retention control system 28 can provide notification of jamming. In the illustrative embodiment, in response to determination of jamming in box 316 (and optionally, failure to overcome jamming via overdrive), the retention control system 28 can communicate with the user to notify that jamming occurs. The retention control system 28 can communicate with a user's personal mobile device 112 to provide a jamming message. In the illustrative embodiment, the retention control system 28 communicates with the user's personal mobile device 112 via facility servers 114 and/or with network 116, and/or communication with the personal mobile device 112 may include local wireless communications, such as Bluetooth, NFC, etc.

The jamming message may include instructions for the user. For example, in the illustrative embodiment, the jamming message can include a visual prompt on a user interface screen thereof indicating for the user to jog the hasp 24 along its path of movement to attempt to dislodge jamming. In some embodiments, the user interface can provide a confirmation button for user input to indicate that jogging has been completed, which may re-initiate operations 310 by returning to check positioning in boxes 312, 314. In some embodiments, notification may include notifying the owner (lessor) of jamming. In some embodiments, notification may include operating the indicator module as a light indicator to flash or change colors indicating jamming.

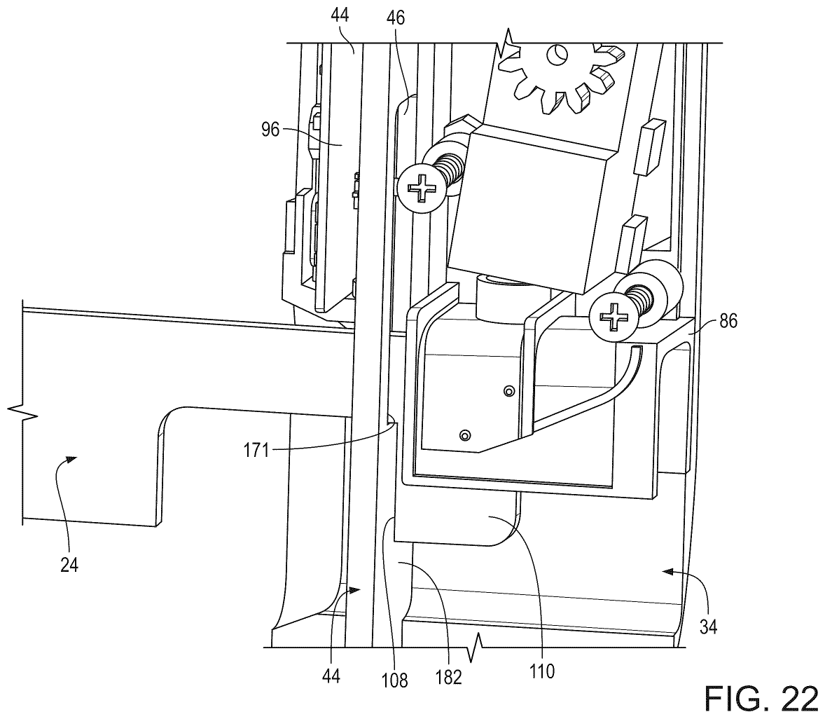

Referring now to FIG. 22, the retention control system 28 can manage mis-operation as jamming in which unlocking is obstructed, referred to as unlocking restricted. For example, as shown in FIG. 22, the hasp 24 and latch plate 44 are engaged in locking. However, the hasp 24 is in contact with the latch plate 44 with enough friction and/or lateral force interaction to obstruct the latch plate 44 from being moved to the unlatched position (downward in the orientation of FIG. 22). Although indicated with the latch plate 44 in the fully latched position (closed position), such unlocking restriction could occur at intermediate positions of the latch plate 44 between the latched and unlatched positions.

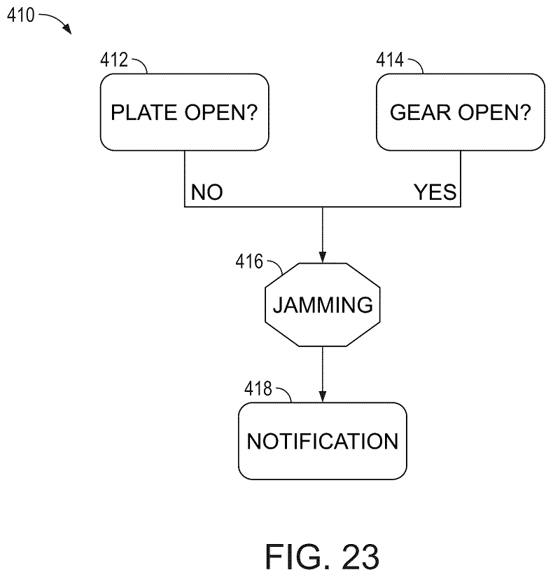

Referring to FIG. 23, the retention control system 28 can determine jamming in operation 410. In the illustrative embodiment, in box 412, the retention control system 28 can determine whether the latch plate 44 is in the open position. The retention control system 28 can detect the sensed position of the latch plate 44 from the latch plate sensor 168, and can determine whether the latch plate 44 is in the open position, illustratively by affirmative sensing or lack thereof by the latch plate sensor 168. In the illustrative embodiment, in box 414, the retention control system 28 can determine whether the gear 66 is in the closed position. The retention control system 28 can detect the sensed position of the gear 66 from the gear sensor 164, and can determine whether the gear 66 has achieved the open position, illustratively by affirmative sensing or lack thereof by the gear sensor 164.

In the illustrative embodiment, in box 416, the retention control system 28 can determine whether jamming occurs. In response to both of: determination that the latch plate is not in the open position, and determination that the gear 66 has achieved the open position, the retention control system 28 determines that jamming occurs as unlocking restricted. In the illustrative embodiment, because the latch plate 44 and the gear 66 are resiliently coupled (via the pivot key 48), the achievement of a fully open position for the gear 66 while the latch plate 44 does not achieve its open position indicates that the latch plate 44 cannot reach its unlatched position downstream of the gear 66. In some embodiments, the retention control system 28 may consider whether a current (upper) threshold of the actuator 64 has been reached (box and/or whether the pivot key 48 is determined to be outside of the closed position according to the pivot key sensor 162.

In box 418, the retention control system 28 can provide notification of jamming. In the illustrative embodiment, in response to determination of jamming in box 416 (and optionally failure to overcome jamming via overdrive), the retention control system 28 can communicate with the user to notify that jamming occurs. The retention control system 28 can communicate with a user's personal mobile device 112 to provide a jamming message. In the illustrative embodiment, the retention control system 28 communicates with the user's personal mobile device 112 via facility servers 114 and/or with network 116, and/or communication with the personal mobile device 112 may include local wireless communications, such as Bluetooth, NFC, etc.

The jamming message may include instructions for the user. For example, in the illustrative embodiment, the jamming message can include a visual prompt on a user interface screen thereof indicating for the user to jog the hasp 24 to attempt to dislodge jamming. In some embodiments, the user interface can provide a confirmation button for user input to indicate that jogging has been completed, which may re-initiate operations 410 by returning to check positioning in boxes 412, 414. In some embodiments, notification may include notifying the owner (lessor) of jamming. In some embodiments, notification may include operating the indicator module as an light indicator to flash or change colors indicating jamming.

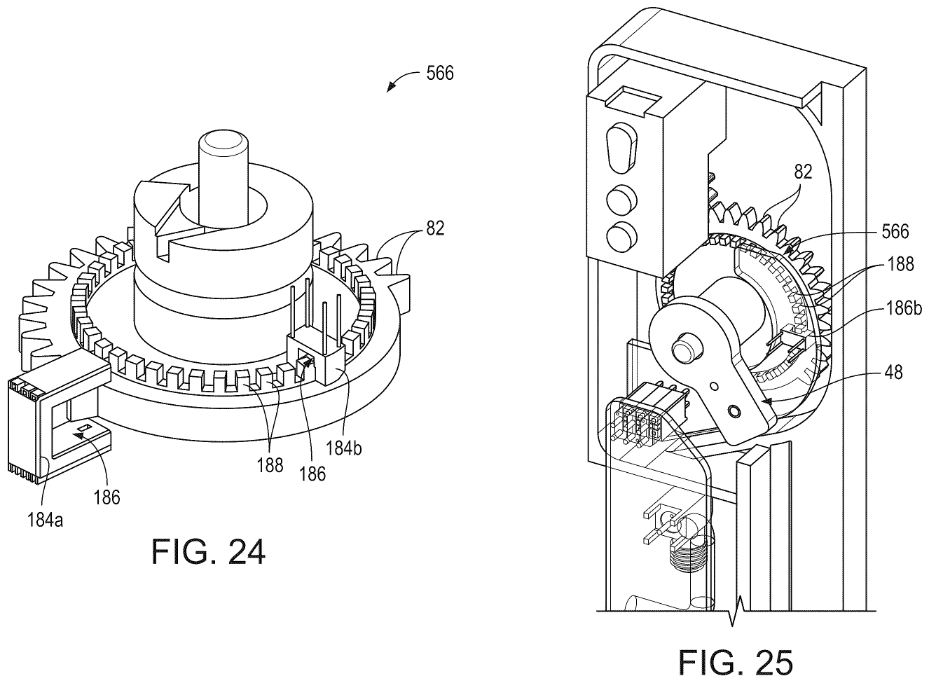

Within the present disclosure, arrangement of sensors on the control board can assist in reducing the costs of sensor deployment while managing the constraints of electronic packaging. In some embodiments, the retention control system 28 may manage an auto-lock operation. Upon unlatching by movement of the latch plate 44 from the latched position to the unlatched position, via movement of the gear 66 rotating the pivot key 48, if the hasp 24 is not moved out from the extended position within a predetermined period of time, the retention control system 28 can responsively operate the operation assembly (including gear and pivot key) for locking. Namely, the retention control system 28 can operate the gear 66 to the closed position to drive the pivot key 48 to the closed position to drive the latch plate to the latched position for locking. Referring now to FIGS. 24 and 25, another embodiment of the electronic lock assembly 16 can include gear 566 similar to gear 66, with the disclosure of gear 66 applying equally to gear 566, except of instances of conflict with the specific disclosure of gear 566. In one application of gear 566, the sensor system 160 can include gear sensor 184 embodied as an optical sensor, such as a photoelectric sensor. The gear sensor 184 illustratively includes a pathway 186 through which light can be sensed such that passage of a component through the pathway 186 blocks light transmission through the pathway 186 thereby indicating the presence of a component. The sensing of the presence (or absence) of a component within the pathway 186 can be applied by the retention control system 28 to determine position of the gear 566.

In a first implementation of the gear sensor 184a, the gear sensor 184 can be arranged to allow passage of the teeth 82 sequentially through the pathway 186 under rotation of the gear 566. As each tooth 82 passes through the pathway 186, the retention control system 28 receives indication of the tooth 82 and can determine the position of the gear 566 along its rotational extent. Such implementation can be applied to gear 66 itself.

In another implementation of gear 566 and gear sensor 184b, the gear 566 includes set of encoder teeth 188 arranged to extend axially from the body 572 in a circular series offset from the axis of rotation of the gear 566. The gear sensor 184 is illustratively arranged to allow passage of the encoder teeth 188 sequentially through the pathway 186 under rotation of the gear 566, such that the retention control system 28 receives indication of the encoder tooth 188 and can determine the position of the gear 566 along its rotational extent. Such optical sensor implementations can enable high resolution of position detection by the retention control system 28. Such optical sensor implementations may be applied in place of or together with gear sensor 164.

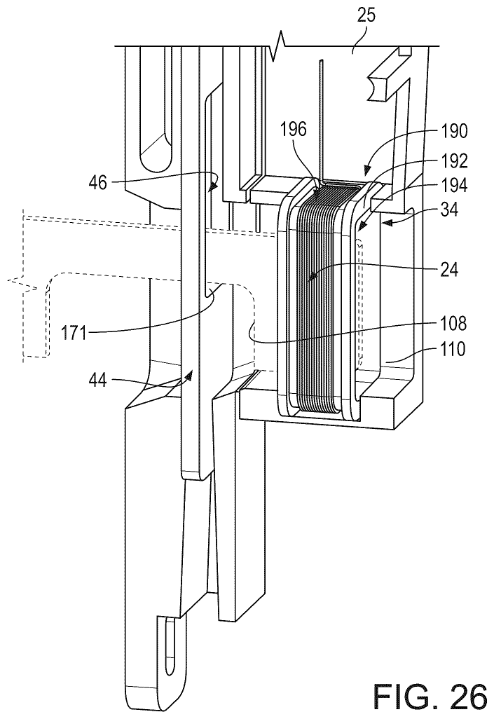

Referring now to FIG. 26, in another instance of hasp position detection, the sensor system 160 can include an inductive sensor 190 arranged to sense the presence of the hasp 24 within the hasp passageway 34. The inductive sensor 190 illustratively includes a frame 192 defining a passage 194 which defines at least a portion of the hasp passageway 34 for receiving the hasp 24 in the extended position, as suggested in FIG. 26.

The inductive sensor 190 illustratively includes a winding 196 comprising a number of wire windings wrapped sequentially around the frame 192. The retention control system 28 passes electrical current through the winding 196 generating an electromagnetic field within the passage 194. The presence of the hasp 24 within the passage 194 disturbs the electromagnetic field allowing the sensor 190 to sense the hasp's presence from which the retention control system 28 can determine whether or not the hasp 24 is within the hasp passageway 34. In the illustrative embodiment, the inductive sensor 190 is applied in place of the sensors 106 and magnet 104, although in some embodiments, sensor 190 and sensors 106 with magnet 104 can be applied simultaneously.

Within the present disclosure, examples of suitable processors may include one or more microprocessors, integrated circuits, system-on-a-chips (SoC), among others. Examples of suitable memory, may include one or more primary storage and/or non-primary storage (e.g., secondary, tertiary, etc. storage); permanent, semi-permanent, and/or temporary storage; and/or memory storage devices including but not limited to hard drives (e.g., magnetic, solid state), optical discs (e.g., CD-ROM, DVD-ROM), RAM (e.g., DRAM, SRAM, DRDRAM), ROM (e.g., PROM, EPROM, EEPROM, Flash EEPROM), volatile, and/or non-volatile memory; among others. Communication circuitry includes components for facilitating processor operations, for example, suitable components may includes transmitters, receivers, modulators, demodulators, filters, modems, analog/digital (AD or DA) converters, diodes, switches, operational amplifiers, and/or integrated circuits.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration only, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media which may be read and executed by one or more processors. A machine-readable medium may include any suitable form of volatile or non-volatile memory.

In the drawings, specific arrangements or orderings of elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships, or associations between elements may be simplified or not shown in the drawings so as not to obscure the disclosure.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

We claim:

1. An electronic lock assembly, comprising:
a hasp assembly configured for coupling with a self-storage door, the hasp assembly including a hasp movable between extended and retracted positions, the hasp including a retention notch;
a hasp retention assembly for selectively retaining the hasp, the hasp retention assembly configured for coupling with a door frame and defining a hasp passageway formed to receive the hasp therein in the extended position, the hasp retention assembly including:
a latch plate arranged for movement between an unlatched position to permit movement of the hasp out of the extended position towards the retracted position and a latched position blocking against movement of the hasp out from the extended position within the hasp passageway towards the retracted position, wherein the latch plate includes a hasp opening arranged to define at least a portion of the hasp passageway, wherein in the extended position within the hasp passageway, the hasp is arranged with alignment between the retention notch and the hasp opening such that arrangement of the latch plate in the latched position engages the latch plate with the retention notch to block against movement of the hasp out from the extended position towards the retracted position, and
an operation assembly configured to operate the latch plate between the unlatched and latched positions, wherein the operation assembly includes a pivot key and a drive gear resiliently coupled with the pivot key to provide rotational force to the pivot key, the pivot key arranged for engagement with the latch plate to provide driving movement of the latch plate between the latched and unlatch positions under rotational pivoting of the pivot key;
a retention control system configured for governing operation of the latch plate between the latched and unlatched positions, the retention control system including a sensor system including at least one pivot key sensor configured to sense positioning of the pivot key and at least one sensor configured to sense positioning of the drive gear.

2. The electronic lock assembly of claim 1, wherein the at least one pivot key sensor is arranged to sense the pivot key being seated in a closed position corresponding with the latched position of the latch plate to establish secure locking of the hasp within the hasp passageway.

3. The electronic lock assembly of claim 2, wherein the sensor system is configured to determine as faulty locking when the pivot key is unseated from, but close to, the closed position.

4. The electronic lock assembly of claim 3, wherein the sensor system is configured to determine as faulty locking upon both of: (i) the pivot key is unseated from, but close to, the closed position, and (ii) the drive gear achieves a closed position corresponding with the latched position of the latch plate.

5. The electronic lock assembly of claim 2, wherein the pivot key includes a pivot key magnet arranged to pass in proximity to the pivot key sensor under movement of the pivot key.

6. The electronic lock assembly of claim 5, wherein the pivot key sensor is arranged on a control board of the retention control system.

7. The electronic lock assembly of claim 6, wherein the pivot key sensor is positioned to one side of the latch plate and the pivot key is positioned to another side of the latch plate opposite the one side.

8. The electronic lock assembly of claim 5, wherein the pivot key includes a body for pivoting rotation about an axis thereof, the pivot key including an arm extending from the body for engagement with the latch plate, wherein the pivot key magnet is positioned to define a magnet path relative to the pivot key sensor under pivoting movement of the pivot key.

9. The electronic lock assembly of claim 5, wherein the pivot key magnet is arranged such that, in the seated position of the pivot key, the pivot key magnet is positioned along the magnet path closest to the pivot key sensor.

10. The electronic lock assembly of claim 5, wherein the pivot key magnet is arranged such that, in the seated position of the pivot key, the pivot key magnet is oriented with a pole end thereof directed towards the pivot key sensor to emphasize magnetic field towards the pivot key sensor.

11. The electronic lock assembly of claim 10, wherein the pivot key magnet is arranged such that, out from the seated position of the pivot key, the pivot key magnet is oriented with the pole end thereof misdirected from the pivot key sensor to deemphasize magnetic field towards the pivot key sensor.

12. The electronic lock assembly of claim 5, wherein the latch plate defines a slot, and the pivot key extends within the slot for selective engagement with an end face defining at least a portion of the slot to maintain the latch plate in the latch position.

13. The electronic lock assembly of claim 5, wherein the pivot key magnet is arranged such that, in the seated position of the pivot key, the pivot key magnet is oriented with a pole end thereof directed towards the pivot key sensor through the slot of the latch plate to emphasize magnetic field towards the pivot key sensor.

14. The electronic lock assembly of claim 1, wherein the drive gear sensor is configured to sense the drive gear positioned in a closed position encouraging the pivot key towards a closed position which corresponds with the latched position of the latch plate.

15. The electronic lock assembly of claim 14, wherein the drive gear includes a gear-closed magnet arranged to pass in proximity to the drive gear sensor under movement of the drive gear to indicate the closed position of the drive gear.

16. The electronic lock assembly of claim 15, wherein the drive gear sensor is arranged on a control board of the retention control system.

17. The electronic lock assembly of claim 16, wherein the drive gear sensor is positioned to one side of the latch plate and the drive gear is positioned to another side of the latch plate opposite the one side.

18. The electronic lock assembly of claim 1, wherein the drive gear sensor is configured to sense the drive gear positioned in an open position encouraging the pivot key into an open position which corresponds with the unlatched position of the latch plate.

19. The electronic lock assembly of claim 18, wherein the drive gear includes a gear-open magnet arranged to pass in proximity to the drive gear sensor under movement of the drive gear to indicate the open position of the drive gear.

20. The electronic lock assembly of claim 1, wherein the retention control system is configured to control the operation assembly for overdrive in response to a determination of jamming.

21. The electronic lock assembly of claim 1, wherein the sensor system includes a latch plate sensor configured to sense positioning of the latch plate.

22. An electronic self-storage locking system, comprising:
a self-storage door assembly comprising a storage door and a door frame;
an electronic lock assembly according to claim 1.

23. An electronic hasp retention system for selectively retaining a hasp of a lock of a self-storage door assembly of a self-storage facility, the hasp retention system comprising:
a hasp retention assembly configured for coupling with a door frame of the self-storage facility and defining a hasp passageway formed to receive the hasp of the lock therein in an extended position, the hasp retention assembly including:
a latch plate arranged for movement between an unlatched position to permit movement of the hasp of the lock out of the extended position towards the retracted position and a latched position blocking against movement of the hasp out from the extended position within the hasp passageway towards the retracted position, wherein the latch plate includes a hasp opening arranged to define at least a portion of the hasp passageway to receive the hasp with alignment between a retention notch and the hasp opening such that arrangement of the latch plate in the latched position can engage the latch plate with the retention notch to block against movement of the hasp out from the extended position towards the retracted position, and
an operation assembly configured to drive the latch plate between the unlatched and latched positions, wherein the operation assembly includes a pivot key and a drive gear resiliently coupled with the pivot key to provide rotational force to the pivot key, the pivot key arranged for engagement with the latch plate to provide driving movement of the latch plate between the latched and unlatch positions under rotational pivoting of the pivot key; and
a retention control system configured for governing operation of the latch plate between the latched and unlatched positions, the retention control system including a sensor system including at least one pivot key sensor configured to sense positioning of the pivot key and at least one sensor configured to sense positioning of the drive gear.
